(19) United States
(12) Patent Application Publication
(10) Pub. No.: US 2025/0259266 A1
(43) Pub. Date: Aug. 14, 2025

(54) VIDEO CODING WITH NEURAL NETWORK (NN)-ARCHITECTURE FOR IN-LOOP FILTERING AND SUPER RESOLUTION

(71) Applicant: QUALCOMM Incorporated, San Diego, CA (US)

(72) Inventors: Dmytro Rusanovskyy, San Diego, CA (US); Yun Li, Ottobrunn (DE); Marta Karczewicz, San Diego, CA (US)

(21) Appl. No.: 19/045,119

(22) Filed: Feb. 4, 2025

Related U.S. Application Data
(60) Provisional application No. 63/551,464, filed on Feb. 8, 2024.

(51) Int. Cl. G06T 3/4053; G06T 3/4046

(52) U.S. Cl. CPC G06T 3/4053; G06T 3/4046

(57) ABSTRACT

A method of processing video data includes receiving, with a headblock of a super resolution (SR) backbone, scale factor information for modifying a resolution of a current block of the video data; filtering, based on the scale factor information, the current block with the SR backbone to generate intermediate filtered data, the SR backbone implementing a neural network (NN)-filter that utilizes the scale factor information; and generating a super resolution current block based on the intermediate filtered data, the super resolution current block having a resolution different than the resolution of the current block.

This application claims the benefit of U.S. Provisional Patent Application 63/551,464, filed Feb. 8, 2024, the entire content of which is incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for neural network-based in-loop filtering (NN-ILF) and super resolution in video coding. One example of the neural network is the convolutional neural network (CNN). A NN-based filter architecture is described for usage as in-loop image enhancement, if coding is conducted at the original resolution. The NN-based filter architecture may also be used for in-loop image re-sampling, if coding is done at the resolution different from original and the image is being restored to the original resolution. The example techniques may improve coding performance under complexity and memory requirements constraints. The example techniques may be used in the context of advanced video codecs, such as extensions of Versatile Video Coding (VVC) or the next generation of video coding standards, and any other video codecs.

In one or more examples, processing circuitry may be configured to implement the NN based filter, and the NN based filter may include a super resolution (SR) backbone, and in some cases, a plurality of SR output layers. One of the inputs to the SR backbone may be scale factor information for modifying a resolution of a current block (e.g., the block that is being filtered). The SR backbone may filter the current block based on the scale factor information to generate intermediate filtered data. By inputting the scale factor information, the SR backbone may generate intermediate filtered data that is optimized to ensure high quality at the target output resolution indicated by the scale factor information.

The processing circuitry may generate a super resolution current block based on the intermediate filtered data. The super resolution current block may have a resolution that is different than the resolution of the current block.

In some cases, it may be possible that the intermediate filtered data is the super resolution current block. However, in examples where the NN based filter includes a plurality of SR output layers, each of the SR output layers may be specifically trained to implement NN-based resampling for a target output resolution to generate a block having the target output resolution. In such examples, the processing circuitry may select one of the plurality of SR output layers based on the scale factor information, and utilize the selected SR output layer for processing the intermediate filtered data to generate the super resolution current block.

In this manner, the processing circuitry may implement the needed SR output layer, instead of implementing all SR output layers, which promotes memory and processing efficiencies. Furthermore, the SR backbone may have a generic structure for all resolutions but may adjust weights and offsets for the intermediate filtered data based on the scale factor information. The plurality of SR output layers may be less complex than the SR backbone, and may also require less training time as compared to examples where there are multiple NN based filters, one for each target output resolution. Accordingly, the example techniques may improve the overall technology of NN based filtering techniques for video processing that is integrated into practical applications of utilizing NN based filtering, such NN-ILF, where the scale factor information is an input to a SR backbone of the NN based filter.

In one example, the disclosure describes a method of processing video data, the method comprising: receiving, with a headblock of a super resolution (SR) backbone, scale factor information for modifying a resolution of a current block of the video data; filtering, based on the scale factor information, the current block with the SR backbone to generate intermediate filtered data, the SR backbone implementing a neural network (NN)-filter that utilizes the scale factor information; and generating a super resolution current block based on the intermediate filtered data, the super resolution current block having a resolution different than the resolution of the current block.

In one example, the disclosure describes a device for processing video data, the device comprising: one or more memories configured to store the video data; and processing circuitry coupled to the one or more memories and configured to: receive, with a headblock of a super resolution (SR) backbone, scale factor information for modifying a resolution of a current block of the video data; filter, based on the scale factor information, the current block with the SR backbone to generate intermediate filtered data, the SR backbone implementing a neural network (NN)-filter that utilizes the scale factor information; and generate a super resolution current block based on the intermediate filtered data, the super resolution current block having a resolution different than the resolution of the current block.

In one example, the disclosure describes a computer-readable storage medium having stored thereon instructions that, when executed, cause one or more processors to: receive, with a headblock of a super resolution (SR) backbone, scale factor information for modifying a resolution of a current block of video data; filter, based on the scale factor information, the current block with the SR backbone to generate intermediate filtered data, the SR backbone implementing a neural network (NN)-filter that utilizes the scale factor information; and generate a super resolution current block based on the intermediate filtered data, the super resolution current block having a resolution different than the resolution of the current block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram of a hybrid video coding framework.

FIG. 3 is a block diagram illustrating an example video encoder that may perform the techniques of this disclosure.

FIG. 4 is a block diagram illustrating an example video decoder that may perform the techniques of this disclosure.

FIG. 5 is a flowchart illustrating an example method for encoding a current block in accordance with the techniques of this disclosure.

FIG. 6 is a flowchart illustrating an example method for decoding a current block of video data in accordance with the techniques of this disclosure.

FIG. 7 is a conceptual diagram illustrating an example of hierarchical prediction structures with GOP size equal to 16.

FIG. 8 is a conceptual diagram illustrating a convolutional neural network (CNN)-based filter with 4 layers.

FIG. 9 is a conceptual diagram illustrating a CNN-based filter with padded input samples and supplementary data.

FIG. 10 is a conceptual diagram illustrating a CNN architecture.

FIG. 11 is a conceptual diagram illustrating an attention residual block of FIG. 10.

FIG. 12 is a conceptual diagram illustrating a spatial attention layer.

FIG. 13 is a conceptual diagram illustrating an example CNN architecture.

FIG. 14 is a conceptual diagram illustrating an example residual block structure of FIG. 13.

FIG. 15 is a conceptual diagram illustrating an example CNN architecture.

FIG. 16 is a conceptual diagram illustrating an example filter block structure of FIG. 15.

FIG. 17 is a conceptual diagram illustrating an example CNN architecture.

FIG. 18 is a conceptual diagram illustrating an example multiscale feature extraction backbone network with two-component convolution.

FIG. 19 is a conceptual diagram illustrating an example unified filter with joint model (joint luma and chroma).

FIG. 20 is a conceptual diagram illustrating an example unified filter with separate luma/chroma models (luma).

FIG. 21 is a conceptual diagram illustrating an example unified filter with separate luma/chroma models (chroma).

FIG. 22 is a conceptual diagram illustrating an architecture of a super-resolution filter.

FIG. 23 is a conceptual diagram illustrating an architecture of a super-resolution filter (low operation point (LOP) configuration).

FIG. 24 is a block diagram of a neural network (NN)-super resolution (SR) filter.

FIG. 25 is a block diagram of the NN-SR filter in output layers targeting different resolutions.

FIG. 26 is a block diagram illustrating NN-SR backbone filter architecture derived from HOP2 (high operation point).

FIG. 27 is a block diagram illustrating NN-SR backbone filter architecture derived from LOP2 (low operation point).

FIGS. 28A and 28B are conceptual diagrams illustrating examples of NN-SR output layers targeting different resolutions.

FIG. 29 is a conceptual diagram illustrating an example of NN-SR output layers allowing fractional scaling factors, such as 1.5.

FIG. 30 is a conceptual diagram illustrating example of a headblock of NN-SR to include scale factor information.

FIG. 31 is a flowchart illustrating an example method of processing video data.

FIG. 32 is a flowchart illustrating an example method of processing video data.

### DETAILED DESCRIPTION

A video decoder reconstructs a current block based on information signaled from a video encoder. The reconstruction process may be lossy, and therefore, there may be visual artifacts present in the current block that degrade visual quality. To improve visual quality, the video decoder may include a filter that filters the current block to generate a filtered block. The filtered block is output for display, and additionally may be used as a reference block for decoding a subsequent block. The video encoder may also include a reconstruction loop that reconstructs the encoded current block in the same manner that the video decoder will reconstruct the current block. The video encoder may also filter the current block in the same manner as the video decoder so that the filtered block at the video encoder side and the filtered block at the video decoder side is the same. This way, when the filtered block is used later as a reference block, the video encoder and the video decoder are using the same reference block with the same sample values.

One example of filtering is changing the resolution of the current block. For instance, the current block of a picture may be encoded and decoded at one resolution, but based on the type of device on which the picture is displayed, there may be benefit in changing the resolution of the current block. For example, if the pictures of the video are displayed on a smart phone, then a lower resolution may be satisfactory, as compared to a higher resolution if pictures of the video are displayed on a high-resolution television.

An example technique to change the resolution is referred to as reference picture resampling (RPR). In RPR, the video encoder and the video decoder may utilize interpolation filters, or other such filters to change the resolution in a way that attempts to maintain the visual quality.

However, while RPR techniques are useful, it may be possible to achieve even better visual quality using neural network (NN) based filtering techniques, sometimes referred to as neural network in-loop filtering (NN-ILF) techniques. In NN-ILF techniques, the processing circuitry of the video encoder or the video decoder implements a trained NN based filter. The input may be the reconstructed block (e.g., current block) and other supplementary inputs such as boundary strength, prediction block used to reconstruct the current block (e.g., reference block of the current block). The NN based filter may extract features from the input, fuse the features, and apply weights and offsets to generate a filtered block.

NN-ILF techniques function well but may require extensive memory and processing power. For instance, if there were a plurality of complete NN-based filters for changing the resolution of the current block to each of a plurality of resolutions, the amount of memory needed to store the NN-based filters, the processing time and power, and training time to train the NN based filters may be more than available. One way to reduce the memory and processing power or time may be to limit the resolutions that the video encoder or video decoder can modify the current block (e.g., limited to only 2× resolution). However, in such cases, the limited options for changing resolution may be unsatisfactory for all use cases.

This disclosure describes example techniques for a super resolution (SR) neural network (NN) (SRNN) based filtering that can support a scaling the current block (e.g., modifying a resolution of the current block) to a plurality of resolutions with reduced impact on processing power or time and memory utilization as compared to other techniques. For instance, the SRNN may include an SR backbone. In accordance with one or more examples described in this disclosure, an input to the SR backbone may be scale factor information that indicates how much to scale the current block to modify the resolution to the current block. The scale factor information may indicate the target scaling factor (e.g., target output resolution), and may also be referred to as the scale factor indicator.

In one or more examples, the SR backbone may include a head block. The head block receives the inputs used to generate a super resolution current block with a different resolution than the current block. For instance, the head block may receive the scale factor information, and other supplementary input data (e.g., context), extract features from the scale factor information and other supplementary input data, and concatenate the extracted features for further processing.

The SR backbone may be configured to filter, based on the scale factor information, the current block to generate intermediate filtered data. As described, the SR backbone may implement a neural network (NN)-filter that utilizes the scale factor information. As one example, the features of the scale factor information, in addition to the other supplementary input data, may together adjust the weights and offsets of the trained SRNN model so that the intermediate filtered data are optimized for generating a super resolution current block at the desired resolution as indicated by the scale factor information. One example of the intermediate filtered data may be luma and chroma component feature data that is further processed to generate the luma and chroma component sample values for the super resolution current block (e.g., the current block having the modified resolution). In some examples, it may be possible for the intermediate filtered data to be the actual luma and chroma component sample values for the super resolution current block.

In one or more examples, in addition to the SR backbone, the SRNN may include a plurality of SR output layers. Each of the plurality of SR output layers may be trained to implement NN-based resampling for a target output resolution to generate a block having the target output resolution. For instance, the first SR output layer may be trained to increase the resolution of the current block by 2×, the second SR output layer may be trained to increase the resolution of the current block by 3×, and so forth. In general, the training time and complexity of the SR output layers may be less than having multiple SRNN filters that are each dedicated to a particular resolution.

For instance, in accordance with one or more examples, the SRNN may include an SR backbone implementing an NN-filter that is common for all resolutions, including no change of resolution. The SR backbone may receive as input the scale factor information, but the processing may be the same for all resolutions. The SRNN may also include a plurality of SR output layers, implementing NN-based resampling to the target output resolution.

In this manner, the intermediate filtered data from the SR backbone (e.g., luma and component feature data) may be optimized for a particular resolution because the scale factor information is an input to the head block of the SR backbone. The processing circuitry of the video encoder and video decoder may select an SR output layer from the plurality of SR output layers based on the scale factor information, and implement that SR output layer for further processing and generating the super resolution current block (e.g., luma and chroma component sample values for the super resolution current block). The processing circuitry may not need to implement all of the SR output layers.

This way, the memory storage and processing power and time of implementing the SR backbone and selected SR output layer may be less than memory storage and processing power and time needed to implement a plurality of different SRNNs that are each for a target output resolution. Stated another way, in some examples, because the SR backbone process and the plurality of SR output layers process are separated in one SRNN, the example techniques may promote memory storage and processing efficiencies as compared to techniques in which multiple end-to-end SRNNs that each support a different target output resolution.

As described above, one technique, in addition to NN based filter techniques of this disclosure, may be RPR techniques to modify resolution of current block. In some examples, the video encoder and the video decoder may utilize RPR techniques in addition to the SRNN to generate the super resolution current block. For instance, the video encoder and the video decoder may utilize the RPR techniques to generate a base layer and utilize the SRNN to generate an enhancement layer. The video encoder and the video decoder may combine the enhancement layer and the base layer to generate the super resolution current block.

In this manner, for devices with low processing capabilities that are unable to process NN based filters, only RPR techniques may be used to generate the super resolution current block. However, for devices with higher processing capabilities, the combination of the base layer from the RPR techniques and the enhancement layer from the SRNN may be combined to generate the super resolution current block.

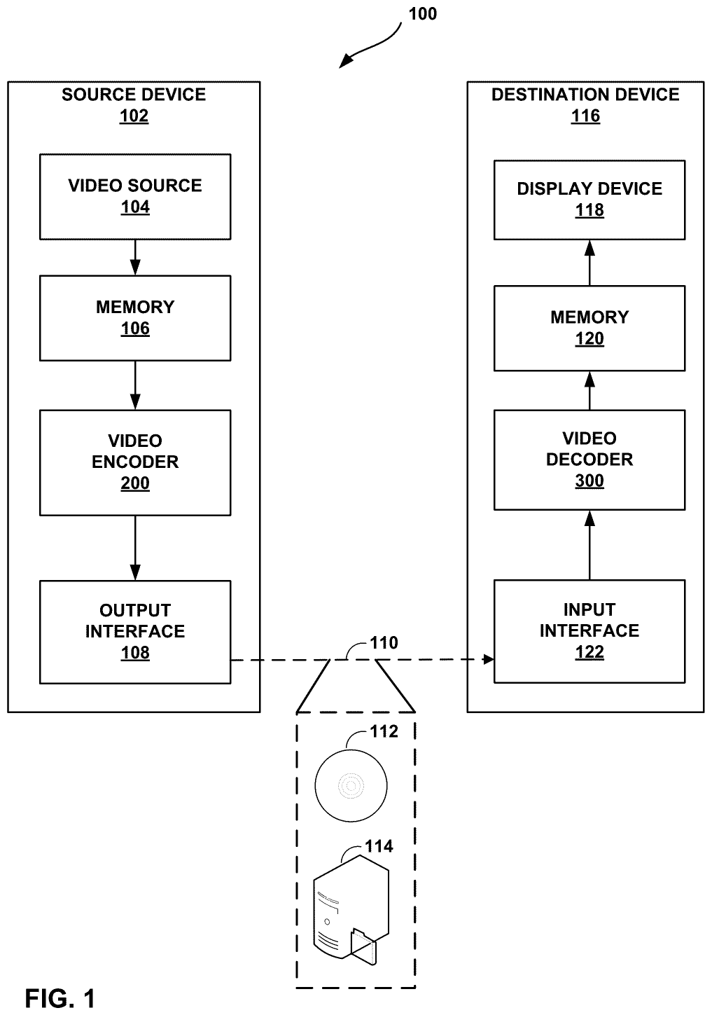

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for neural network-based in-loop filtering. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for neural network based in-loop filtering. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). A draft of the VVC standard is described in Bross, et al. “Versatile Video Coding (Draft 10),” Joint Video Experts Team (JVET) of ITU-T SG 16 WP 3 and ISO/IEC JTC 1/SC 29/WG 11, 18^{th} Meeting: by teleconference, 22 Jun.-1 Jul. 2020, JVET-S2001-vA (hereinafter “VVC Draft 10”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

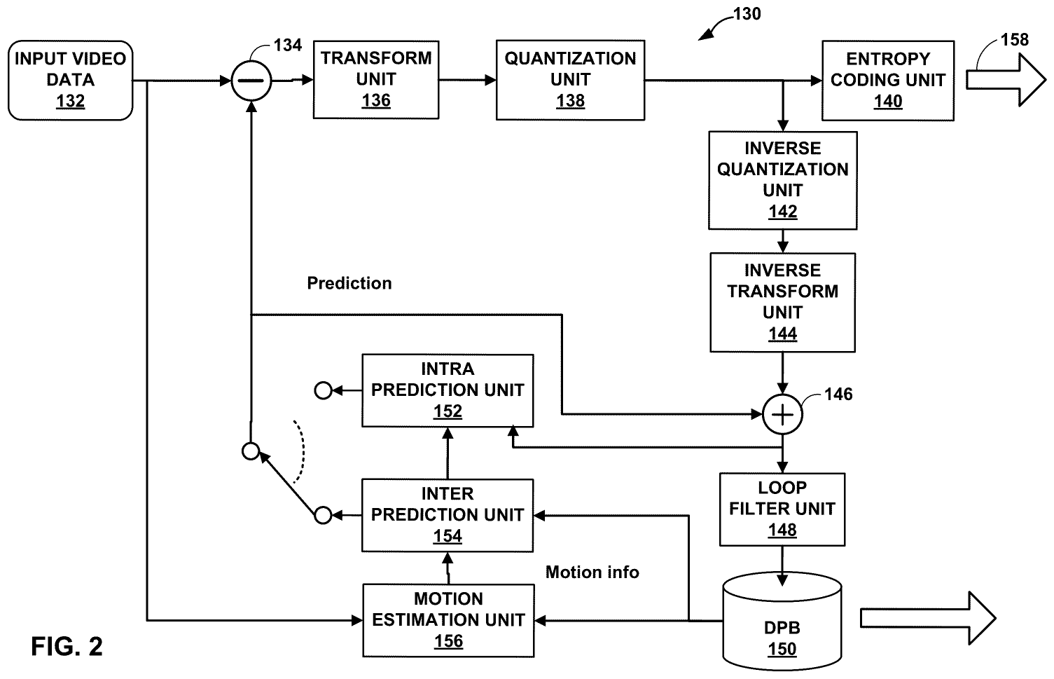

All video coding standards since H.261 have been based on the so-called hybrid video coding principle, which is illustrated in FIGS. 2-4. The term hybrid refers to the combination of two means to reduce redundancy in the video signal, i.e., prediction and transform coding with quantization of the prediction residual. Whereas prediction and transforms reduce redundancy in the video signal by decorrelation, quantization decreases the data of the transform coefficient representation by reducing their precision, ideally by removing only irrelevant details. This hybrid video coding design principle is also used in the two most recent standards HEVC and VVC. As shown in FIG. 2, a modern hybrid video coder is composed for various building blocks.

FIG. 2 is a conceptual diagram illustrating a hybrid video coding framework. As shown in FIG. 2, a modern hybrid video coder 130 generally performs block partitioning, motion-compensated or inter-picture prediction, intra-picture prediction, transformation, quantization, entropy coding, and post/in-loop filtering. In the example of FIG. 2, video coder 130 includes summation unit 134, transform unit 136, quantization unit 138, entropy coding unit 140, inverse quantization unit 142, inverse transform unit 144, summation unit 146, loop filter unit 148, decoded picture buffer (DPB) 150, intra prediction unit 152, inter-prediction unit 154, and motion estimation unit 156.

In general, video coder 130 may, when encoding video data, receive input video data 132. Block partitioning is used to divide a received picture (image) of the video data into smaller blocks for operation of the prediction and transform processes. Early video coding standards used a fixed block size, typically 16×16 samples. Recent standards, such as HEVC and VVC, employ tree-based partitioning structures to provide flexible partitioning.

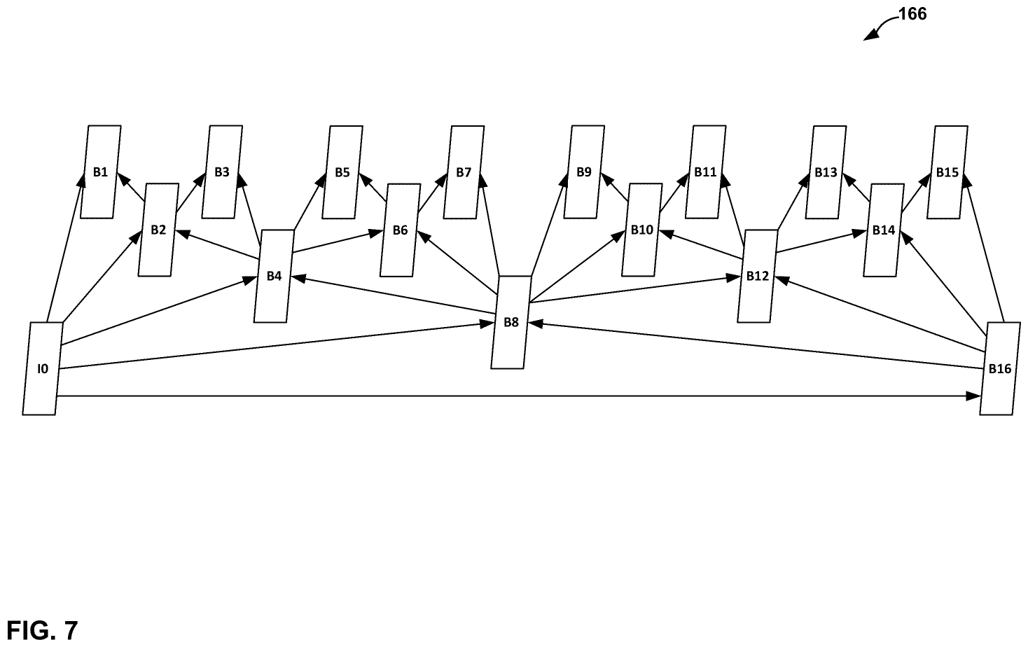

Motion estimation unit 156 and inter-prediction unit 154 may predict input video data 132, e.g., from previously decoded data of DPB 150. Motion-compensated or inter-picture prediction takes advantage of the redundancy that exists between (hence “inter”) pictures of a video sequence. According to block-based motion compensation, which is used in the modern video codecs, the prediction is obtained from one or more previously decoded pictures, e.g., the reference picture(s). The corresponding areas to generate the inter-prediction are indicated by motion information, including motion vectors and reference picture indices. In recent video codecs, hierarchical prediction structures inside a group of pictures (GOP) is applied to improve coding efficiency. FIG. 7 is a conceptual diagram illustrating an example of hierarchical prediction structures 166 with GOP size equal to 16.

Summation unit 134 may calculate residual data as differences between input video data 132 and predicted data from intra prediction unit 152 or inter-prediction unit 154. Summation unit 134 provides residual blocks to transform unit 136, which applies one or more transforms to the residual block to generate transform blocks. Quantization unit 138 quantizes the transform blocks to form quantized transform coefficients. Entropy coding unit 140 entropy encodes the quantized transform coefficients, as well as other syntax elements, such as motion information or intra-prediction information, to generate output bitstream 158.

Meanwhile, inverse quantization unit 142 inverse quantizes the quantized transform coefficients, and inverse transform unit 144 inverse transforms the transform coefficients, to reproduce residual blocks. Summation unit 146 combines the residual blocks with prediction blocks (on a sample-by-sample basis) to produce decoded blocks of video data. Loop filter unit 148 applies one or more filters (e.g., at least one of a neural network-based filter, a neural network-based loop filter, a neural network-based post loop filter, an adaptive in-loop filter, or a pre-defined adaptive in-loop filter) to the decoded block to produce filtered decoded blocks.

A block of video data, such as a CTU or CU, may in fact include multiple color components, e.g., a luminance or “luma” component, a blue hue chrominance or “chroma” component, and a red hue chrominance (chroma) component. The luma component may have a larger spatial resolution than the chroma components, and one of the chroma components may have a larger spatial resolution than the other chroma component. Alternatively, the luma component may have a larger spatial resolution than the chroma components, and the two chroma components may have equal spatial resolutions with each other. For example, in 4:2:2 format, the luma component may be twice as large as the chroma components horizontally and equal to the chroma components vertically. As another example, in 4:2:0 format, the luma component may be twice as large as the chroma components horizontally and vertically. The various operations discussed above may generally be applied to each of the luma and chroma components individually (although certain coding information, such as motion information or intra-prediction direction, may be determined for the luma component and inherited by the corresponding chroma components).

Intra-picture prediction exploits spatial redundancy that exists within a picture (hence “intra”) by deriving the prediction for a block from already coded/decoded, spatially neighboring (reference) samples. The directional angular prediction, DC prediction and plane or planar prediction are used in the most recent video codec, including AVC, HEVC, and VVC.

Hybrid video coding standards apply a block transform to the prediction residual (regardless of whether it comes from inter- or intra-picture prediction). In early standards, including H.261, H.262, and H.263, a discrete cosine transform (DCT) is employed. In HEVC and VVC, more transform kernel besides DCT are applied, in order to account for different statistics in the specific video signal.

Quantization aims to reduce the precision of an input value or a set of input values in order to decrease the amount of data needed to represent the values. In hybrid video coding, quantization is typically applied to individual transformed residual samples, i.e., to transform coefficients, resulting in integer coefficient levels. In recent video coding standards, the step size is derived from a so-called quantization parameter (QP) that controls the fidelity and bit rate. A larger step size lowers the bit rate but also deteriorates the quality, which e.g., results in video pictures exhibiting blocking artifacts and blurred details.

Entropy coding unit 140 may perform context-adaptive binary arithmetic coding (CABAC) on encoded video. CABAC is used in recent video codecs, e.g. AVC, HEVC and VVC, due to its high efficiency.

Loop filter unit 148 may perform post-loop or in-loop filtering. Post/In-Loop filtering is a filtering process (or combination of such processes) that is applied to the reconstructed picture to reduce the coding artifacts. The input of the filtering process is generally the reconstructed picture (or reconstructed block of a picture), which is the combination of the reconstructed residual signal (e.g., the reconstruction samples), where the reconstruction samples include quantization error, and the prediction (e.g., the prediction samples). As shown in FIG. 2, the reconstructed pictures after in-loop filtering are stored in decoded picture buffer (DPB) 150 and are used as a reference for inter-picture prediction of subsequent pictures.

The coding artifacts are mostly determined by the QP (quantization parameter), therefore QP information is generally used in design of the filtering process. In HEVC, the in-loop filters include deblocking filtering and sample adaptive offset (SAO) filtering. In the VVC standard, an adaptive loop filter (ALF) was introduced as a third filter. The filtering process of ALF is as shown below:

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad ( 1 )$$

where can R(i,j) is the samples before filtering process, R′(i,j) is the sample value after filtering process. f(k,l) denotes the filter coefficients, K(x,y) is the clipping function and c(k,l) denotes the clipping parameters. The variable k and l varies between

$$- \frac{L}{2}$$

and

$$\frac{L}{2}$$

where L denotes the filter length. The clipping function K(x,y)=min(y,max(−y,x)) which corresponds to the function Clip3 (−y,y,x). The clipping operation introduces non-linearity to make ALF more efficient by reducing the impact of neighbor sample values that are too different with the current sample value. In VVC, the filtering parameters can be signalled in the bit stream, it can be selected from the pre-defined filter sets. The ALF filtering process can also be summarised as following equation.

$${R}^{′} ( i , j ) = R ( i , j ) + ALF\_residual \_ouput ( R ) \qquad ( 2 )$$

Adaptive Resolution Change (ARC) is a process of changing spatial resolution during video content coding or delivery (e.g. broadcast, or streaming) in order to adapt parameters of the coded bitstreams to changing network conditions. In earlier generations of video coding standards, such as AVC or HEVC, changing spatial resolution may require a key frame, such as an IDR, to be sent to reset the stream and allow start at the new spatial resolution. The latter video coding technology, such as VVC, the Reference Picture Resampling (RPR) coding tool was introduced to allow spatial resolution change within a coded video sequence. In RPR, a spatial resolution of coded image can be changed with a predefined resolution ratio according to encoding strategy, and the decoded image can be used as reference picture even if the spatial resolutions of coded and reference picture are not matching. To achieve resolutions alignment, a normative up- and down-sampling are being applied to the reference picture.

RPR is supported in the VVC Main 10 profile and while VVC allows high flexibility with regards to scaling factors and frequency of resolution change at any picture, application specifications may provide some constraints on how often and which resolutions can be used by the codec. For example, specification of DVB TS 101 154, which allows RPR use in VVC profiles, restricts downsampling scaling factors to ⅔ and ½ while new coded resolutions can be introduced at minimum interval of 2 seconds. However, different application standards may choose to adopt different sets of constraints for the use of RPR functionality.

The following describes neural network (NN) based filtering for video coding. Many works show that embedding neural networks into a hybrid video coding framework can improve compression efficiency. Neural networks have been used for intra prediction and inter prediction to improve the prediction efficiency. Neural network (NN)-based in-loop filtering is also a prominent research topic in recent years. In some works, the filtering process is applied as a post-filter. In this case, the filtering process is only applied to the output picture and the unfiltered picture is used as reference picture.

The NN-based filter can be applied additionally to the existing filters such as deblocking filter, SAO and ALF. The NN-based filter can also be applied exclusively, where it is designed to replace all the existing filters.

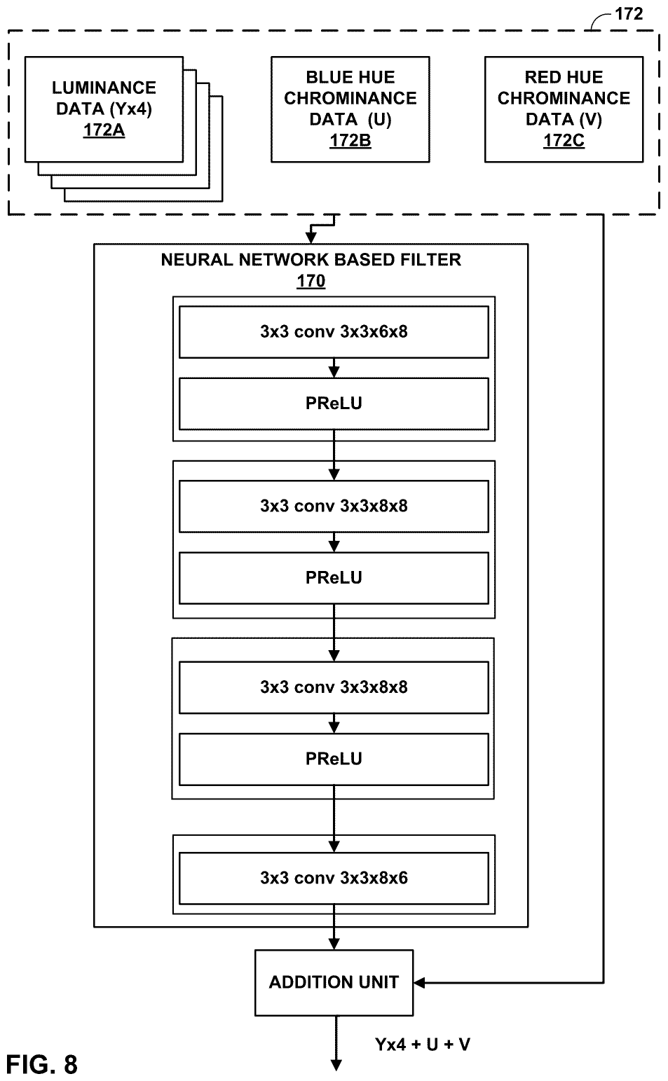

An example of an NN-based filter is shown in FIG. 8. FIG. 8 is a conceptual diagram illustrating a CNN-based filter with 4 layers. The NN-based filtering process takes the reconstructed luma and chroma samples, packed in a 3D volume with 6 planes. As inputs, and the intermediate outputs are residual samples, which are added back to the input to refine the input samples. The NN-based filter may use all color components as input to exploit the cross-component correlations. The different component may share the same filters (including network structure and model parameters) or each component has its own specific filters.

For instance, NN-based filter 170 can be applied in addition to the existing filters, such as deblocking filters, sample adaptive offset (SAO), and/or adaptive loop filtering (ALF). NN-based filters can also be applied exclusively, where NN-based filters are designed to replace all of the existing filters. Additionally, or alternatively, NN-based filters, such as NN-based filter 170, may be designed to supplement, enhance, or replace any or all of the other filters.

The NN-based filtering process of FIG. 8 may take the reconstructed samples (e.g., luma and chroma samples which, in some examples, may be packed in a 3D volume with 6 planes) as inputs, and the intermediate outputs are residual samples, which are added back to the input to refine the input samples. The NN-based filter may use all color components (e.g., Y, U, and V, or Y, Cb, and Cr, e.g., luminance data 172A, blue-hue chrominance 172B, and red-hue chrominance 172C) as inputs 172 to exploit cross-component correlations. Different color components may share the same filter(s) (including network structure and model parameters) or each component may have its own specific filter(s).

The filtering process can also be generalized as follows:

$${R}^{′} ( i , j ) = R ( i , j ) + NN\_filter \_residual \_ouput ( R ) \qquad ( 3 )$$

The model structure and model parameters of NN-based filter(s) can pre-defined and be stored at encoder and decoder. The filters can also be signalled in the bit stream.

In the example of FIG. 8, the NN-based filter 170 may include a series of feature extraction layers, followed by an output convolution. In FIG. 8, the feature extraction layers may include a 3×3 convolution (conv) layer followed by a parametric rectified linear unit (PReLU) layer. The convolution layer applies a convolution operation to the input data, which involves a filter or kernel sliding over the input data (e.g., the reconstruction samples of input 172) and computing dot products at each position. The convolution operation essentially captures local patterns within the input data. For example, in the context of image processing, these patterns could be edges, textures, or other visual features. The filter or kernel is a small matrix of weights that gets updated during the training process. By sliding this filter across the input data (or feature map from a previous layer) and computing the dot product at each position, the convolution layer creates a feature map that encodes spatial hierarchies and patterns detected in the input.

The output of a convolution layer is a set of feature maps, each corresponding to one filter, capturing different aspects of the input data. This layer helps the neural network to learn increasingly complex and abstract features as the data passes through deeper layers of the network. The first 3×3 in the nomenclature 3×3 conv 3×3×6×8 in FIG. 8 indicates that the convolution layer has a 3×3 filter size (e.g., a 3×3 matrix). 3×3×6×8 refers to both the input and output dimensions of the convolution layer, where 6 is the number of input channels, and 8 is the number of output channels.

The PRELU layer is an activation function used in neural networks, and was introduced as a variant of the ReLU (Rectified Linear Unit) activation function. As described above, the convolution layer outputs feature maps, each corresponding to one filter, representing detected features in the input. Following the convolution layer, the PRELU layer applies the PRELU activation function to each element of the feature maps produced by the convolution layer. For positive values, the PRELU layer acts like a standard ReLU, passing the value through. For negative values, instead of setting them to zero (e.g., as ReLU does), the PRELU layer allows a small, linear, negative output. This keeps the neurons active and maintains the gradient flow, which can be beneficial for learning in deep networks.

In summary, when a convolution layer is followed by a PRELU layer, the convolution layer first extracts features from the input data through a set of learned filters. The resulting feature maps are then passed through the PRELU activation function, which introduces non-linearity and helps to avoid the problem of dying neurons by allowing a small gradient when the inputs are negative. This combination is effective in learning complex patterns in the data while maintaining robust gradient flow, especially beneficial in deeper network architectures.

When NN-based filtering is applied in video coding, the whole video signal (pixel data) might be split into multiple processing units (e.g. 2D blocks), and each processing unit can be processed separately or be combined with other information associated with this block of pixels. The possible choices of processing unit include a frame, a slice/tile, a CTU or any pre-defined or signaled shapes and sizes.

To further improve the performance of NN-based filtering, different types of input data can be processed jointly to produce the filtered output. Input data may include, but not limited to, reconstructed, prediction pixels, pixels after the loop filter(s), partitioning structure information, deblocking parameters (boundary strength (BS)), quantization parameter (QP) values, slice or picture types or filters applicability or coding modes map. Input data can be provided at the different granularity. Luma reconstruction and prediction samples could be provided at the original resolution, whereas chroma samples could be provided at lower resolution, e.g., for 4:2:0 representation, or can be up-sampled to the Luma resolution to achieve per-pixel representation. Similarly, QP, BS, partitioning or coding mode information can be provided at lower resolution, including cases with a single value per frame/slice or processing block (e.g., QP), or this value can be expanded (replicated) to achieve per-pixel representation.

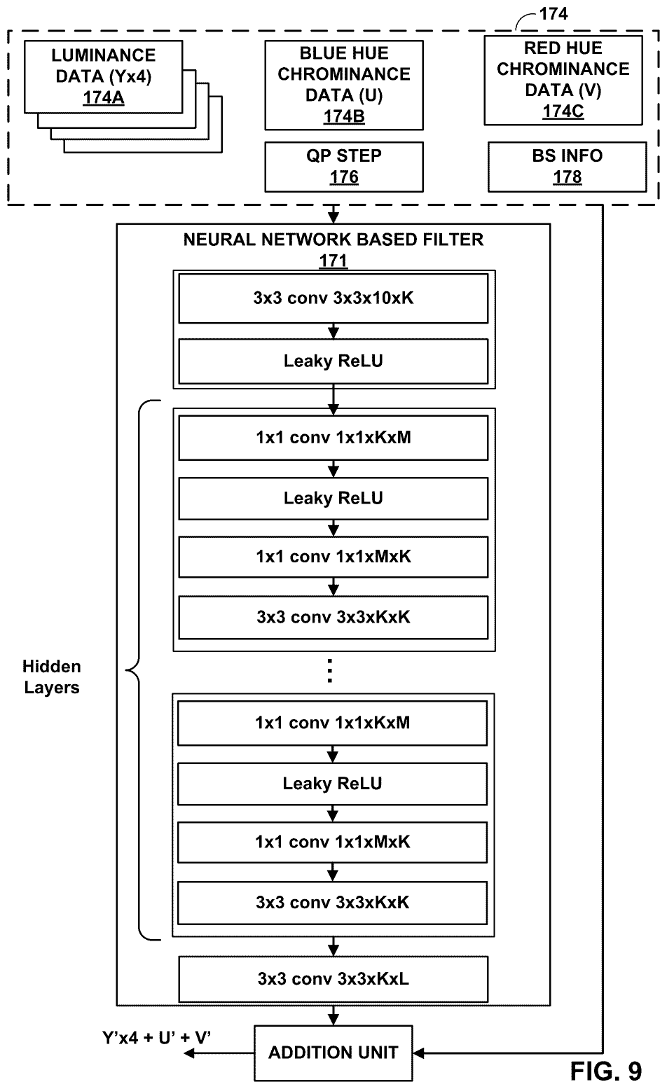

An example of an architecture utilizing supplementary data was proposed in Wang et al “EE1-1.4: Test on Neural Network-based In-Loop Filter with Large Activation Layer,” JVET-V0115, April 2021 (hereinafter, JVET-V0115) and shown in FIG. 9. FIG. 9 is a conceptual diagram illustrating a CNN-based filter with padded input samples and supplementary data. Pixels of the processing block (4 subblocks of interlaced Luma samples plane and associated Cb and Cr planes) are combined with supplementary information such as QP steps and BS. The area of the processing pixel is extended with 4 padded pixels from each side. The total size of the processing volume is (4+64+4)×(4+64+4)×(4 Y+2UV+1QP+3BS).

For example, NN-based filter 171 uses pixels/samples of the processing block combined with supplementary data as input 174. The input 174 may include 4 subblocks of interlaced luma samples (Yx4) 174A and associated blue hue chrominance (U) data 174B and red hue chrominance (V) data 174C. The supplementary data includes a quantization parameter (QP) step 176 and a boundary strength (BS) 178. The area of the input pixels/samples may be extended with 4 padded pixels/samples from each side. The resulting dimensions of the processing volume is (4+64+4)×(4+64+4)×(4 Y+2UV+1QP+3BS).

Relative to the NN-based filter in FIG. 8, NN-based filter 171 may include two or more hidden layers that utilize both 1×1 convolutions and a Leaky ReLU layer. A leaky ReLU layer. Similar to a PRELU layer, a Leaky ReLU layer allows a small, non-zero gradient to be output when the layer is not active. Instead of outputting zero for negative inputs, the Leaky ReLU multiplies these inputs by a small constant. This small slope ensures that even neurons that would otherwise be inactive still contribute a small amount to the network's learning, reducing the likelihood of the dying ReLU problem.

Video encoder 200 and video decoder 300 may be configured to perform NN-based filtering with multi-mode design. To further improve the performance of NN based filtering, multi-mode solutions can be designed. For example, for each processing unit, encoder may select among a set of modes based on rate-distortion optimization and the choice can be signaled in the bit-stream, the different modes may include different NN models, different values that used as the input information of the NN models. As an example, Y. Li et al “EE1-1.7: Combined Test of EE1-1.6 and EE1-1.3,” JVET-Z0113, April 2022 (hereinafter, JVET-Z0113) proposed a NN based filtering solution that created multiple modes based on a single NN model by using different QP values as input of the NN model for different modes.

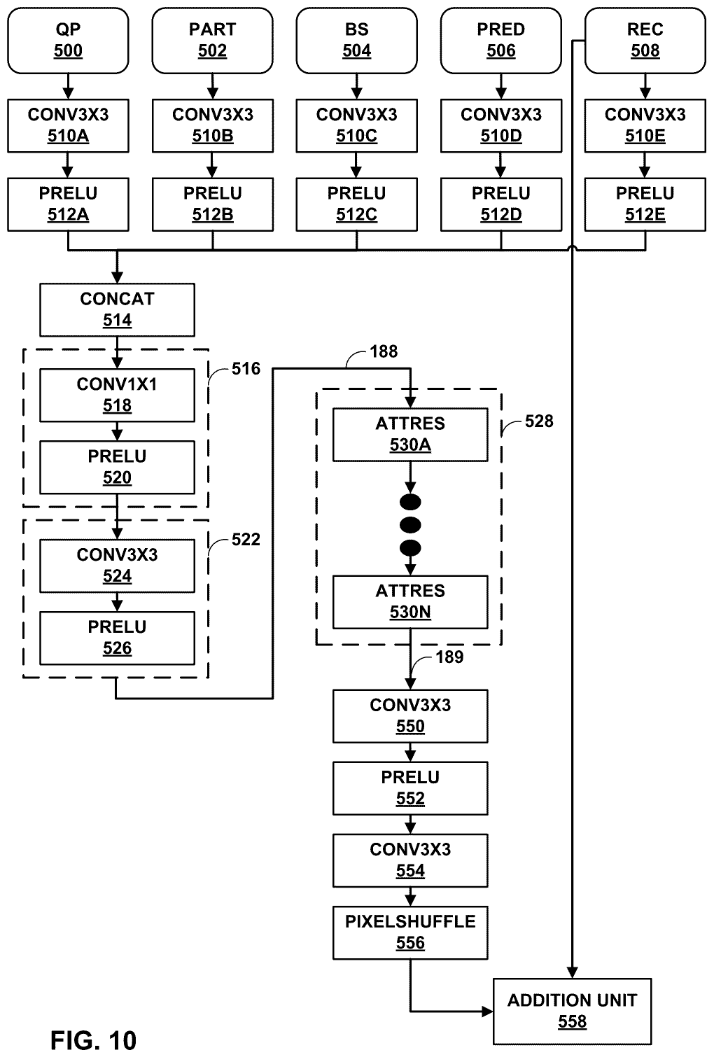

This following section presents examples of CNN In-Loop Filtering (ILF) architecture that are being actively developed in JVET. In JVET-Z0113, an NN based filtering solution with multiple modes was proposed. The structure of the network is shown in FIG. 10. FIG. 10 is a conceptual diagram illustrating a CNN architecture.

In the first part (FIG. 10), the different input data types are convolved with number of kernels size of 3×3 to produce feature maps, undergo activation and results for each data type are concatenated, fused and subsampled once to create the output y. The number of feature maps used in JVET-Z0113 is 96. This output is then fed through N=8 attention residual blocks, each one with the structure shown in FIG. 10. The output from the last attention residual block z is fed into the last part of the network.

For example, the NN-based filter of FIG. 10 includes a first portion including input 3×3 convolutions 510A-510E and respective parametric rectified linear units (PReLUs) 512A-512E for each of the inputs to generate feature maps (e.g., the feature extraction section of the NN-filter). Concatenation unit 514 concatenates the feature maps and provides them to fuse block 516 and transition block 522. While shown as fuse block 516 and transition block 522, in some examples, fuse block 516 and transition block 522 may together be referred to as a fusion block. The NN-based filter in FIG. 10 further includes a set 528 of attention residual (AttRes) blocks 530A-530N; and a last portion (e.g., the tail section) including 3×3 convolution 550, PRELU 552, 3×3 convolution 554, and pixel shuffle unit 556. The AttRes blocks may also be referred to as backbone blocks.

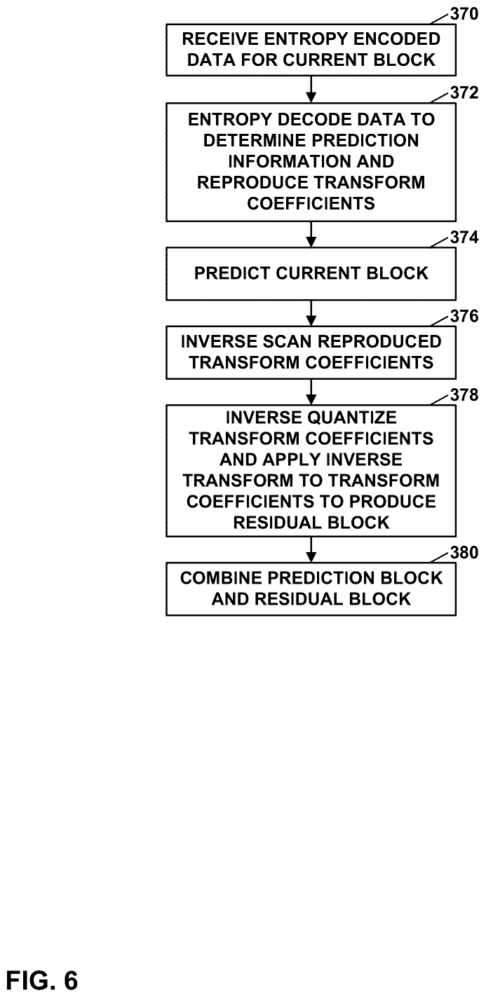

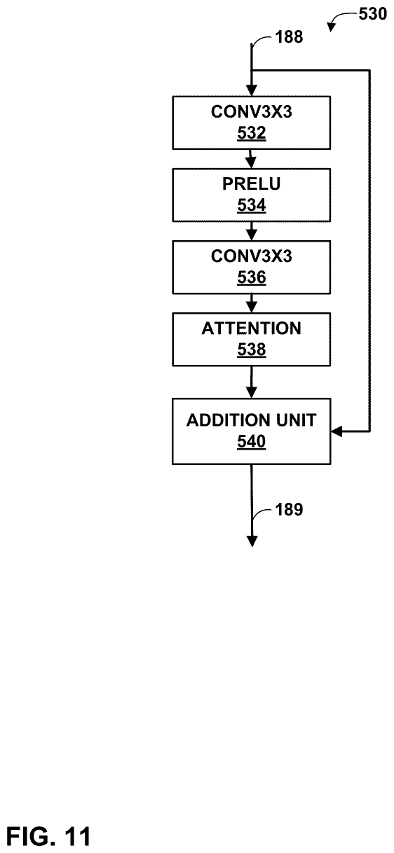

In the first portion (e.g., the feature extraction section), different inputs, including quantization parameter (QP) 500, partition information (part) 502, boundary strength (BS) 504, prediction information (pred) 506, and reconstruction samples (rec) 508 are received. Respective 3×3 convolutions 510A-510E and PRELUs 512A-512E convolve and activate the respective inputs to produce feature maps. Concatenation unit 514 then concatenates the feature maps. Fuse block 516, including 1×1 convolution 518 and PRELU 520, fuses the concatenated feature maps. Transition block, including 3×3 convolution 524 and PRELU 526, subsamples the fused inputs to create output 188. Output 188 is then fed through set 528 of attention residual blocks 530A-530N, which may include a various number of attention residual blocks, e.g., 8. The attention block is explained further with respect to FIG. 11. Output 189 from the last of the set 528 of attention residual blocks 530 is fed to the last portion of the NN-based filter. In the last portion, which may be a tail block, 3×3 convolution 550, PRELU 552, 3×3 convolution 554, and pixel shuffle unit 556 processes output 189, and addition unit 558 combines this result with the original input reconstructed samples 508. This ultimately forms the filtered output for presentation and storage as reference for subsequent inter-prediction, e.g., in a decoded picture buffer (DPB). In some examples, the NN-based filter of FIG. 6 uses 96 feature maps.

FIG. 11 is a conceptual diagram illustrating an attention residual block of FIG. 10. That is, FIG. 11 depicts attention residual block 530, which may include components similar to those of attention residual blocks 530A-530N of FIG. 10. In this example, attention residual block 530 includes first 3×3 convolution 532, parametric rectified linear unit (PRELU) filter 534, second 3×3 convolution 536, an attention block 538, and addition unit 540. Addition unit 540 combines the output of attention block 538 and output 188, initially received by convolution 532, to generate output 189.

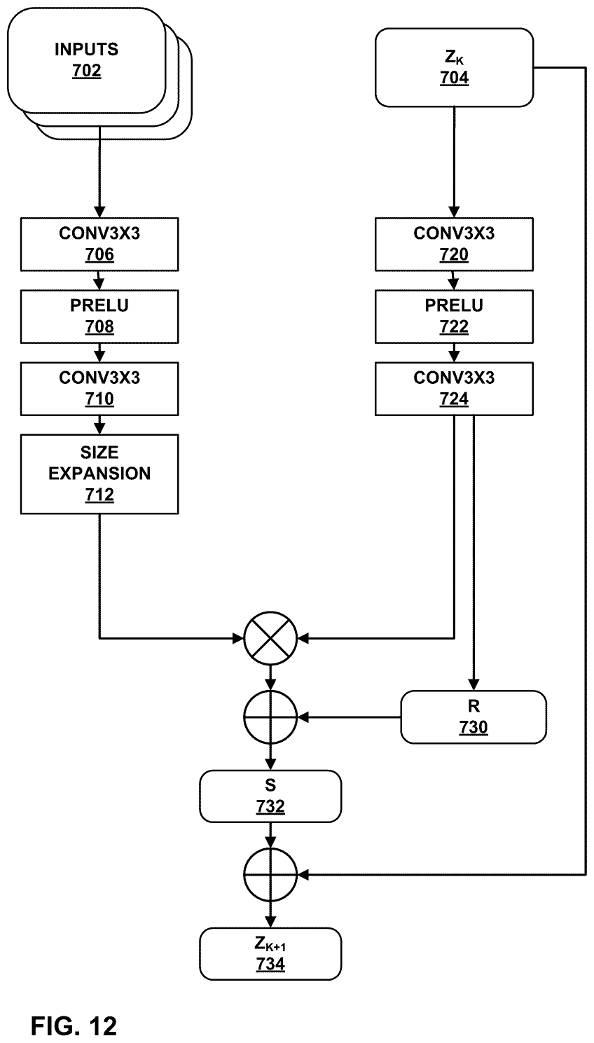

The spatial attention layer in AttRes block is illustrated in FIG. 12 in JVET-Z0113. FIG. 12 is a conceptual diagram illustrating a spatial attention layer. As shown in FIG. 12, a spatial attention layer of attention residual block 530 includes 3×3 convolution 706, PRELU 708, 3×3 convolution 710, size expansion unit 712, 3×3 convolution 720, PRELU 722, and 3×3 convolution 724. 3×3 convolution 706 receives inputs 702, corresponding to quantization parameter (QP) 500, partition information (part) 502, boundary strength (BS) 504, prediction information (pred) 506, and reconstructed samples (rec) 508 of FIG. 10. 3×3 convolution 720 receives Z_{K} value 704. The outputs of size expansion unit 712 and 3×3 convolution 724 are combined, and then combined with R value 730 to generate S value 732. S value 732 is then combined with Z_{K} value 704 to generate output Z_{K+1} value 734.

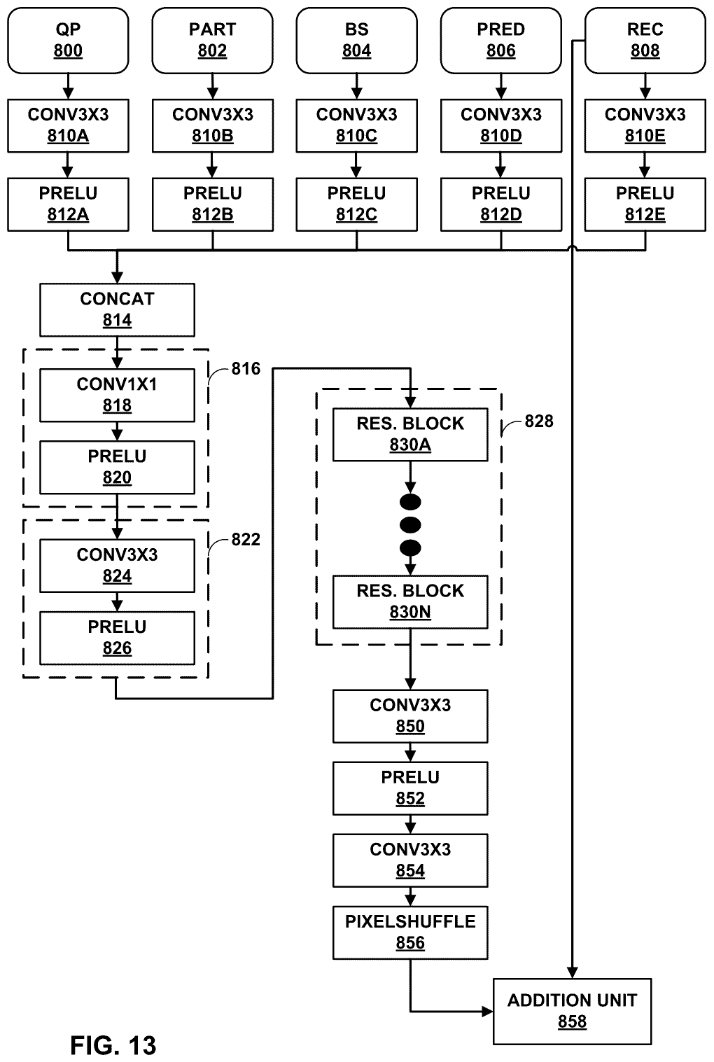

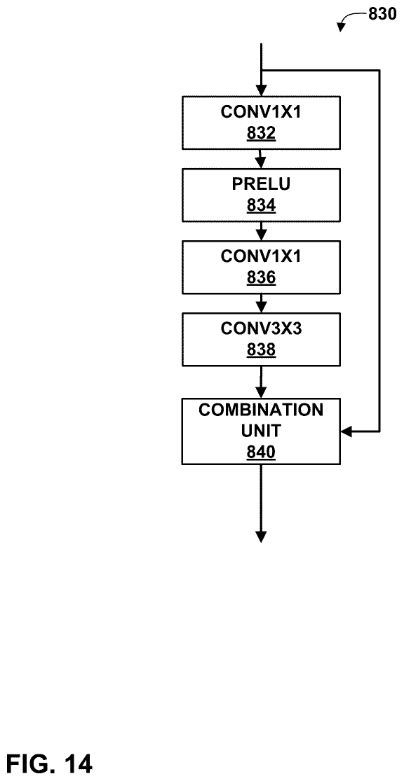

In S. Eadie, M. Coban, M. Karczewicz, EE1-1.9: Reduced complexity CNN-based in-loop filtering, JVET-AC0155, January 2023 (hereinafter, “JVET-AC0155”), an alternative design of NN architecture was proposed. It was proposed to use larger number of low complexity residual blocks in the backbone of the JVET-Z0113 CNN filter along with reduced number of channels (feature maps) and removal of the attention modules. The proposed CNN filtering structure (for Luma filtering) is shown in FIG. 13. FIG. 13 is a conceptual diagram illustrating an example CNN-architecture. FIG. 14 shows the CNN architecture of JVET-AC0155 for a filter block.

FIG. 13 is a block diagram illustrating an example of a simplified CNN-based filter architecture. The NN-based filter of FIG. 13 includes 3×3 convolutions 810A-810E and PRELUs 812A-812E, which convolve corresponding inputs, i.e., QP 800, Part 802, BS 804, Pred 806, and Rec 808 to generate feature maps (e.g. the feature extraction section). Concatenation unit 814 concatenates the convolved inputs (e.g., the feature maps). Fuse block 816 then fuses the concatenated feature maps using 1×1 convolution 818 and PRELU 820. Transition block 822 then processes the fused data using 3×3 convolution 824 and PRELU 826. While shown as fuse block 816 and transition block 822, in some examples, fuse block 816 and transition block 822 may together be referred to as a fusion block.

In this example, the NN-based filter includes a set 828 of residual blocks 830A-830N (also called backbone blocks), each of which may be structured according to residual block structure 830 of FIG. 14, as discussed below. Residual blocks 830A-830N may replace AttRes blocks 530A-530N of FIG. 10. The example of FIG. 13 may be used for luminance (luma) filtering, although as discussed below, similar modifications may be made for chrominance (chroma) filtering.

The number of residual blocks and channels included in set 828 of FIG. 13 can be configured differently. That is, N may be set to a different value, and the number of channels in residual block structure 830 may be set to a number different than 160, to achieve different performance-complexity tradeoffs. Chroma filtering may be performed with these modifications for processing of chroma channels.

Set 828 of residual blocks 830A-830N has N instances of residual block structure 830. In one example, N may be equal to 32, such that there are 32 residual block structures. Residual blocks 830A-830N may use 64 feature maps, which is reduced relative to the 96 feature maps used in the example of FIG. 10.

In the last portion of FIG. 13, 3×3 convolution 850, PRELU 852, 3×3 convolution 854, and pixel shuffle unit 856 processes output of set 828, and addition unit 858 combines this result with the original input reconstructions samples (REC) 808. This ultimately forms the filtered output for presentation and storage as reference for subsequent inter-prediction, e.g., in a decoded picture buffer (DPB).

The quantity of residual blocks used is M=24. The quantity of feature maps (convolutions) is reduced to 64. In the ResBlocks, the quantity of channels firstly goes up to 160 before the activation layer, and then goes down to 64 after the activation layer. The number of residual blocks and channels can be configured differently (M set to another value and the number of channels in the residual block can be set to a number different than 160) for different performance-complexity trade-offs. Chroma filtering follows the concept in JVET-Z0113 (e.g., of FIG. 10) with the above modifications to its backbone for processing of chroma channels.

FIG. 14 is a conceptual diagram illustrating an example residual block structure 830 of FIG. 13. In this example, residual block structure 830 includes first 1×1 convolution 832, which may increase a number of input channels to 160, before an activation layer (PRELU 834) processes the input channels. PRELU 834 may thereby reduce the number of channels to 64 through this processing. Second 1×1 convolution 836 then processes the reduced channels, followed by 3×3 convolution 838. Finally, combination unit 840 may combine the output of 3×3 convolution 838 with the original input received by residual block structure 830.

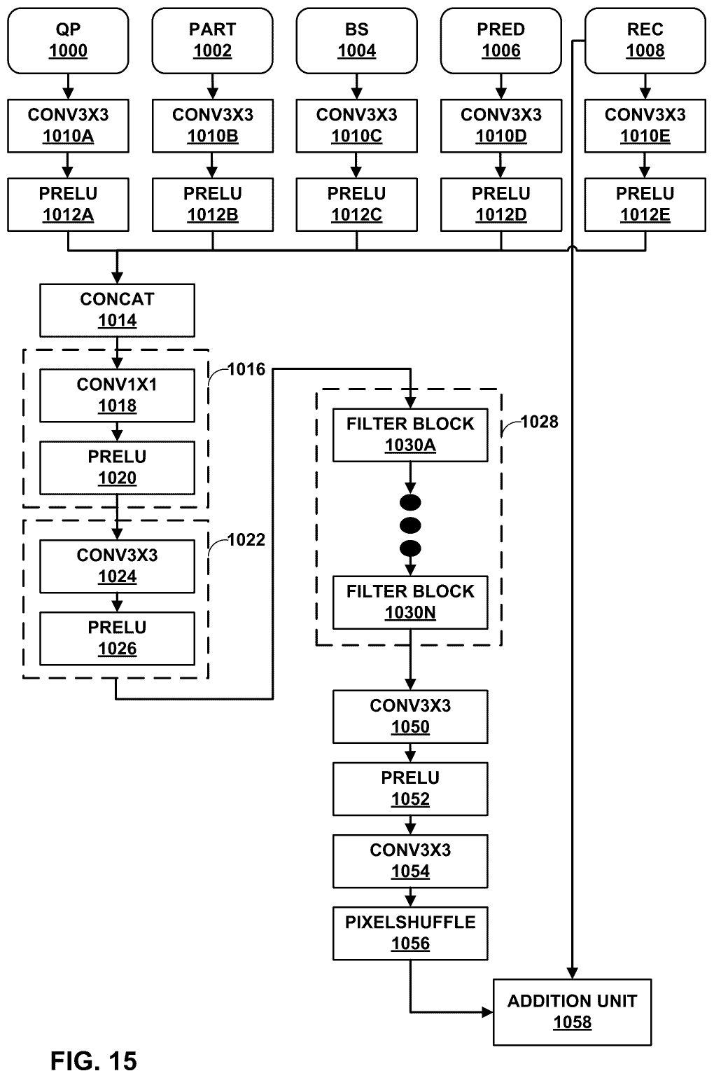

In a further modification, the bypass branch around convolution and activation layers in the residual block in the previous solution is removed, as shown in FIG. 15. The number of channels and number of filter blocks can be configurable, for example, 64 channels, 24 filter blocks, with 160 channels before and after the activation, which results in the the complexity of the network is 605.93 kMAC and the number of parameters is 1.5M for the intra luma model.

Further complexity reduction of CCN ILF architecture is achieved with utilization of the separable convolution in place of 2D convolutions (3×3). In Seregin et al., “EE2: Summary report of exploration experiment on enhanced compression beyond VVC capability” JVET-AD0023, (hereinafter, “JVET-AD0023”), EE1 test 1.3.5, a low-rank convolution approximation decomposes a 3×3×M×N convolution into a pixel-wise convolution (1×1×M×R), two separable convolutions (3×1×R×R, 1×3×R×R) and another pixel-wise convolution (1×1×R×N) was applied to the residual block of the architecture described in JVET-AC0155. Here, R is the rank of the approximation, and can ablate the performance/complexity of the approximation.

FIG. 15 is a conceptual diagram illustrating another example filtering block structure that may be substituted for the set of attention residual blocks of FIG. 10 according to the techniques of this disclosure. The NN-based filter of FIG. 15 includes 3×3 convolutions 1010A-1010E and PRELUs 1012A-1012E, which convolve respective inputs, i.e., QP 1000, Part 1002, BS 1004, Pred 1006, and Rec 1008 to form feature maps (e.g., the feature extraction section). Concatenation unit 1014 concatenates the feature maps. Fuse block 1016 then fuses the concatenated inputs using 1×1 convolution 1018 and PRELU 1020. Transition block 1022 then processes the fused data using 3×3 convolution 1024 and PRELU 1026. While shown as fuse block 1016 and transition block 1022, in some examples, fuse block 1016 and transition block 1022 may together be referred to as a fusion block.

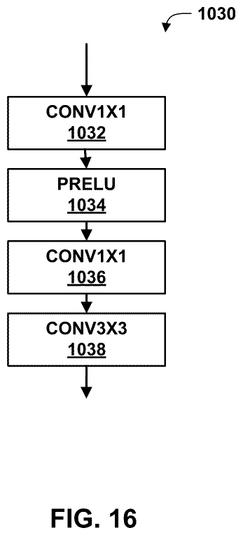

In this example, the NN-based filtering unit includes a set 1028 of N filter blocks 1030A-1030N (also called backbone blocks), each of which may have the structure of filter block structure 1030 of FIG. 16 as discussed below. Filter block structure 1030 may be substantially similar to residual block structure 830, except that combination unit 840 is omitted from filter block structure 1030, such that input is not combined with output. Instead, output of each residual block structure may be fed directly to the subsequent block.

In the last portion of FIG. 15, 3×3 convolution 1050, PRELU 1052, 3×3 convolution 1054, and pixel shuffle unit 1056 processes output of set 1028, and addition unit 1058 combines this result with the original input reconstructions samples (REC) 1008. This ultimately forms the filtered output for presentation and storage as reference for subsequent inter-prediction, e.g., in a decoded picture buffer (DPB).

FIG. 16 is a conceptual diagram illustrating an example filter block structure 1030 of FIG. 15. In this example, filter block structure 1030 includes first 1×1 convolution 1032, which may increase a number of input channels to 160, before an activation layer (PReLU 1034) processes the input channels. PReLU 1034 may thereby reduce the number of channels to 64 through this processing. Second 1×1 convolution 1036 then processes the reduced channels, followed by 3×3 convolution 1038. As discussed above, filter block structure 1030 does not include a combination unit, in contrast with the residual block structure 830 of FIG. 14.

In one example, the architecture of FIG. 15, with decomposition illustrated in FIG. 16, is implemented with parameters K=64, M=160 and R=51, and total number of 24 residual blocks results in the complexity of the network is 356.43 kMAC and the number of parameters is 1.07M for the intra luma model.

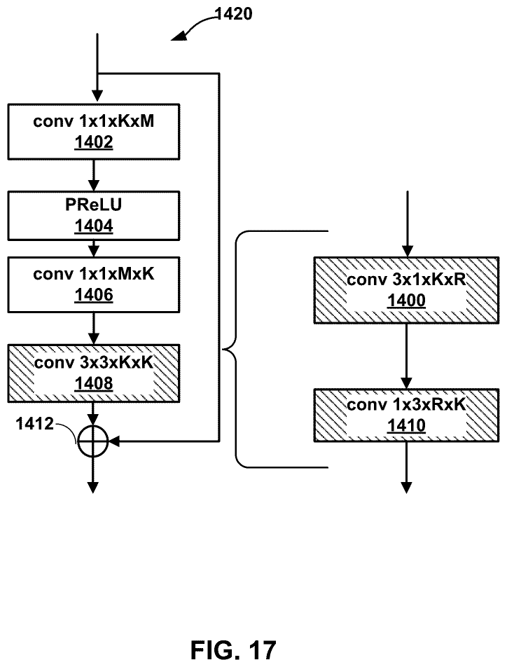

FIG. 17 is a block diagram illustrating an example multiscale feature extraction backbone network with two-component convolution. The example of FIG. 17 may use of an approximation of a 3×3×K×K convolution with a 3×1×K×R convolution and a 1×3×R×K convolution.

In the example of FIG. 17, residual block 1420 includes a 1×1×K×M convolution 1402, followed by PRELU 1404. The output of PRELU 1404 is input to 1×1×M×K convolution 1406. A 3×3×K×K convolution 1408 of residual block 1420 is approximated by a 3×1×K×R convolution 1400 and then a 1×3×R×K convolution 1410. The output of 1×3×R×K convolution 1410 may be input to combination unit 1412 which may combine the output of 1×3×R×K convolution 1410 with an input to 1×1×K×M convolution 1402. R is the canonical rank of the decomposition. A lower rank implies a larger complexity reduction.

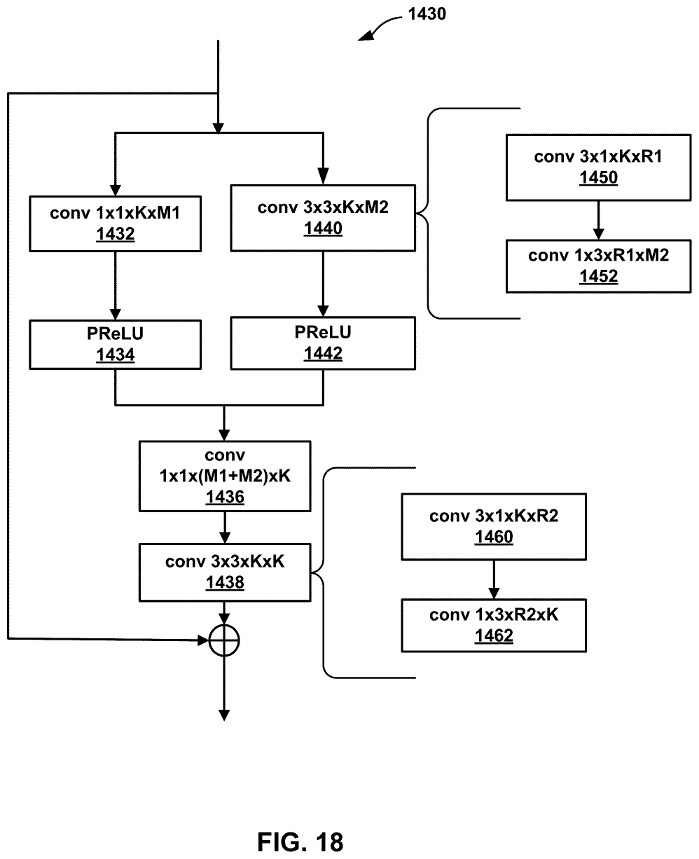

A multiscale feature extraction with a two-component convolution network is proposed in Y. Li, S. Eadie, D. Rusanovskyy, M. Karczewicz, EE1-Related: Combination test of EE1-1.3.5 and multi-scale component of EE1-1.6, JVET-AD0211, April 2023 (hereinafter, “JVET-AD0211”), which is illustrated in FIG. 18, the 3×3 convolutions are decomposed into a 3×1×C1×R convolution and followed by a 1×3×R×C2 convolution, where C1 and C2 are the number of input and output channels, respectively, and R is the rank of the approximation. The parameter R can be made proportional to R=C1×C2/(C1+C2) and controls the complexity of the approximation.

FIG. 18 is a conceptual diagram illustrating an example multiscale feature extraction backbone network with two-component convolution. FIG. 18 shows an architecture with 3×3 convolution blocks being replaced by separable convolutions of 3×1 and 1×3. In this example, residual block structure 1430 includes first 1×1 convolution 1432 before a first activation layer (PReLU 1434) and, in parallel with the first 1×1 convolution 1432 and PRELU 1434, a 3×3 convolution 1440 and a second activation layer (PRELU 1442). A second 1×1 convolution 1436 then processes the combined output of PRELU 1434 and PRELU 1442, followed by 3×3 convolution 1438. In the example of FIG. 18, however, 3×3 convolution 1440 may be approximated using a plurality of separable convolutions, shown as 3×1 convolution 1450 and 1×3 convolution 1452 in FIG. 18. Similarly, 3×3 convolution 1438 may be approximated using a plurality of separable convolutions, shown as 3×1 convolution 1460 and 1×3 convolution 1462 in FIG. 18.

As an example, the architecture illustrated in FIG. 18 can be implemented with parameters R1=8, R2=44, M1=160 and M2=16, and total number of 24 residual blocks, the complexity of the network will be 358.43 kMAC and the number of parameters is 1.07M for the intra luma model.

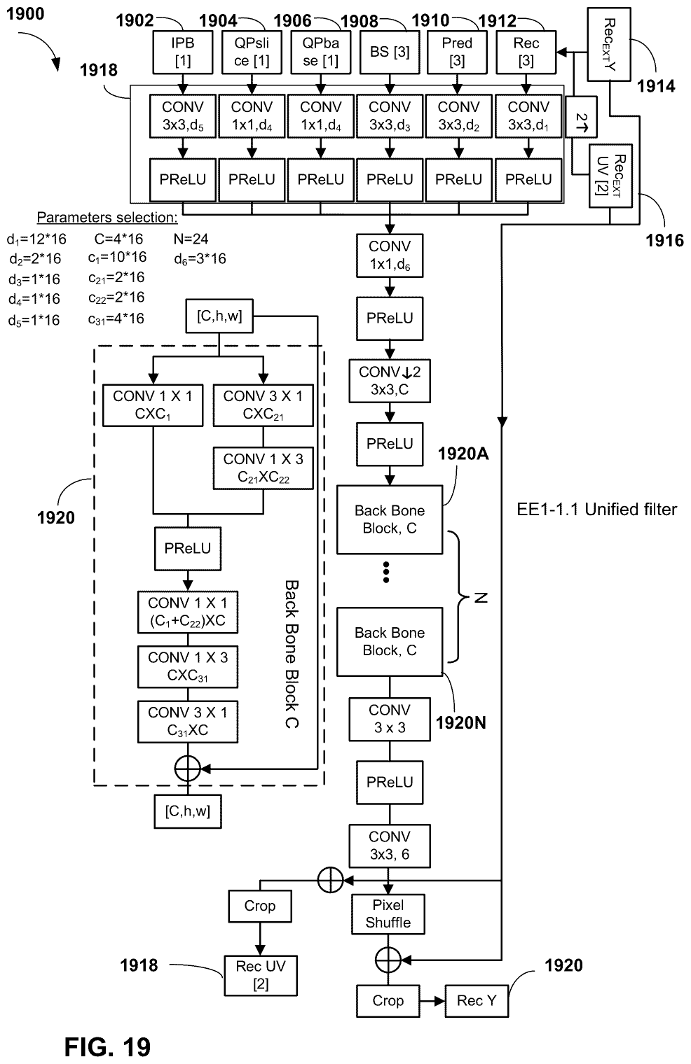

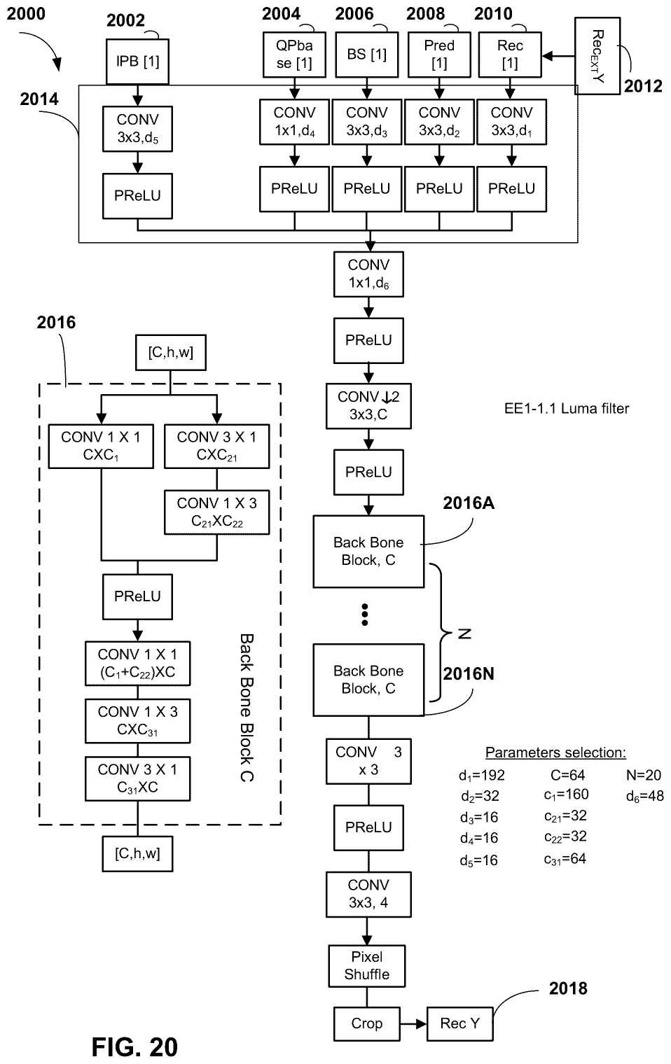

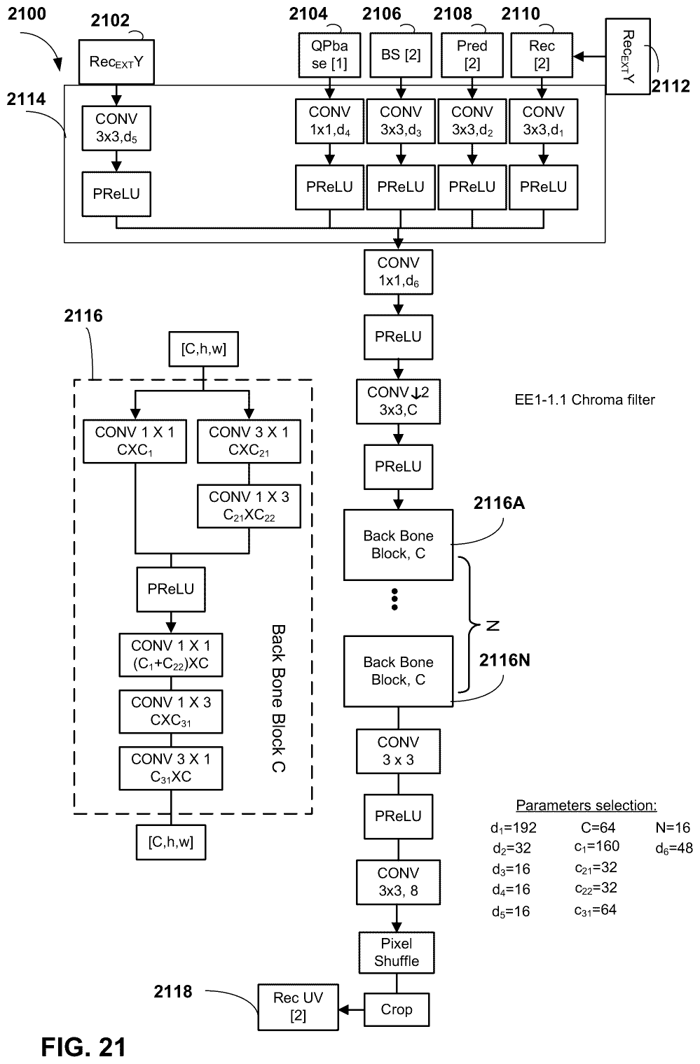

The multiscale feature extraction backbone with the two-component decomposition has been integrated into the unified model in EE. In addition, the specification from the EE contains two versions of the model, which are 1) a unified model for joined luma and chroma, see FIG. 19, and 2) separate models for luma and chroma, respectively, see FIG. 20 and FIG. 21. FIG. 19 is a conceptual diagram illustrating an example unified filter with joint model (joint luma and chroma). FIG. 20 is a conceptual diagram illustrating an example unified filter with separate luma/chroma models (luma). FIG. 21 is a conceptual diagram illustrating an example unified filter with separate luma/chroma models (chroma).

The various components illustrated in FIGS. 19-21 may be similar to other similarly references components above. FIG. 19 illustrates an example where the output is the reconstructed (e.g., filtered) luma and chroma components using the same architecture. FIG. 20 illustrates an example where the output is the reconstructed luma component, and FIG. 21 illustrates an example where the output is the reconstructed chroma components, where the luma and chroma filtering (e.g., reconstruction) is performed separately in FIGS. 20 and 21.

For example, FIG. 19 illustrates unified filter 1900 that receives as inputs IPB mode 1902 (e.g., whether intra-frame (I), predicted frame (P), or bi-directional predicted frame (B)), the QP slice parameter 1904, the QP base parameter 1906, the boundary strength (BS) 1908, the prediction block (e.g., block used to predict current block) 1910, current block 1912, luma component 1914, and chroma components 1916. The inputs are processed through the convolution and PRELU components of headblock 1918.

The output from headblock 1918 is combined and processed through convolution layers and PRELU blocks, and then process through backbone blocks 1920A-1920N. FIG. 19 also illustrates an example backbone block 1920.

Because filter 1900 is a unified filter, the luma and chroma components are processed together. Using a pixel shuffle and crop operation, the luma and chroma components are separated out to generate filtered chroma components 1918 and filtered luma components 1920.

FIG. 20 illustrates luma filter 2000 that receives as inputs IPB mode 2002 (e.g., whether intra-frame (I), predicted frame (P), or bi-directional predicted frame (B)), the QP base parameter 2004, the boundary strength (BS) 2006, the prediction block (e.g., block used to predict current block) 2008, current block 2010, and luma component 2012. The inputs are processed through the convolution and PRELU components of headblock 2014.

The output from headblock 2014 is combined and processed through convolution layers and PReLU blocks, and then process through backbone blocks 2016A-2016N. FIG. 20 also illustrates an example backbone block 2016.

Because filter 2000 is a luma filter, the luma component is processed separately from the chroma components. Using a pixel shuffle and crop operation, the luma components are separated out to generate filtered luma components 2018.

FIG. 21 illustrates chroma filter 2100 that receives as inputs IPB mode 2102 (e.g., whether intra-frame (I), predicted frame (P), or bi-directional predicted frame (B)), the QP base parameter 2104, the boundary strength (BS) 2106, the prediction block (e.g., block used to predict current block) 2108, current block 2110, and luma component 2112. The inputs are processed through the convolution and PReLU components of headblock 2114.

The output from headblock 2114 is combined and processed through convolution layers and PRELU blocks, and then process through backbone blocks 2116A-2116N. FIG. 21 also illustrates an example backbone block 2116.

Because filter 2100 is a chroma filter, the chroma components are processed separately from the luma component. Using a pixel shuffle and crop operation, the chroma components are separated out to generate filtered chroma components 2118.

The following describes CNN filter architecture for super resolution. There are two CNN-based filter architectures for Super Resolution have been proposed, tested, and adopted to JVET NNVC reference software.

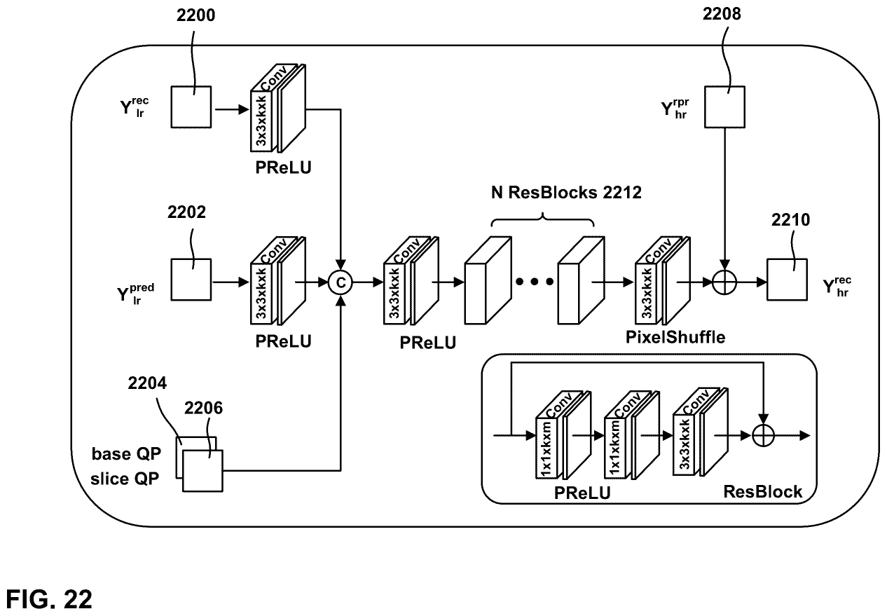

The SR design proposed in Chang et al. “EE1-2.2: GOP Level Adaptive Resampling with CNN-based Super Resolution,” JVET-AC0196, January 2023, (hereinafter JVET-AC0196), is shown in FIG. 22. FIG. 22 is a conceptual diagram illustrating an architecture of a super-resolution filter.

Along with the low-resolution reconstruction Yₗᵣ^{rec} 2200, the low-resolution prediction Yₗᵣ^{pred} 2202, slice QP 2206 and base QP 2204 are also fed into the proposed network. The RPR reconstruction Yₕᵣ^{rpr} 2208 upsampled by conventional RPR mechanism is adopted to generate the high-resolution reconstruction Yₕᵣ^{rec} 2210. The number of resblocks 2212 is set to 24, and the channels K and M in the resblock 2212 are set to 64 and 192 respectively. The NN structure for chroma is similar to the network structure for luma. Since the cross-component correlation is beneficial to the super resolution of chroma components, the luma reconstruction is fed into the network. Besides, the slice type is also taken as one input for better generalization. Separate models are trained for I slices and B slices.

Another SR (super resolution) design proposed in Lin et al. “AHG11: Unified CNN super resolution for resampling-based video coding) JVET-AF0143, October 2023 (hereinafter “JVET-AF0143”) utilized a modified Unified Filter Architecture described above to introduce SR methods with HOP (high operation point) (˜470 kMAC/pixel) and LOP (low operation point) complexity (˜20 kMAC/pixel). The later model introduced changes that were limited to removal of the Transition Block which conducted convolution with stride 2. For the HOP configuration, the SR architecture would include Backbone block and configuration similar to that described in FIG. 16. A single model is trained for both, Y and CbCr components and Intra and Inter coded picture.

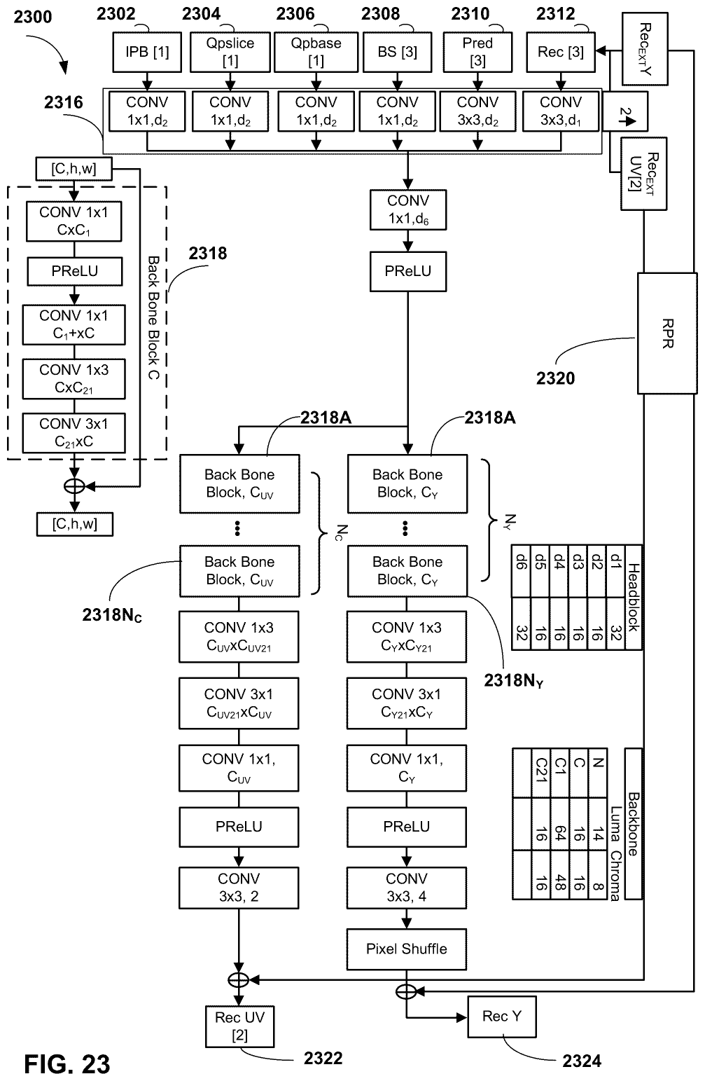

FIG. 23 is a conceptual diagram illustrating an architecture of a super-resolution filter (low operation point (LOP) configuration). For instance, FIG. 23 illustrates the architecture of the super-resolution filter (LOP configuration) proposed in JVET-AF0143.

FIG. 23 illustrates combined luma and chroma filter 2300 that receives as inputs IPB mode 2302 (e.g., whether intra-frame (I), predicted frame (P), or bi-directional predicted frame (B)), the QP slice parameter 2304, the QP base parameter 2306, the boundary strength (BS) 2308, the prediction block (e.g., block used to predict current block) 2310, current block 2312 including reconstructed luma and chroma components. The inputs are processed through the convolution and PRELU components of headblock 2316.

The output from headblock 2316 is combined and processed through convolution layers and PRELU blocks, and then process through backbone blocks 2318A-2318N_{Y} for luma filtering, and through backbone blocks 2318A-2318N_{C} for chroma filtering. FIG. 23 also illustrates an example backbone block 2318.

Because filter 2300 is a unified filter, the luma and chroma components are processed together. Using a pixel shuffle and crop operation, the luma and chroma components are separated out to generate filtered chroma components 2322 and filtered luma components 2324.

In the example of FIG. 23, filter 2300 may also include RPR block 2320, which may perform reference picture resampling of the reconstructed luma and chroma components but with interpolation filters or other such filters. For instance, in some examples, RPR block 2320 may not utilize NN-based techniques. In filter 2300, the output from RPR block 2320 may be combined with the outputs from the NN-based techniques to generate filtered chroma components 2322 and filtered luma components 2324.

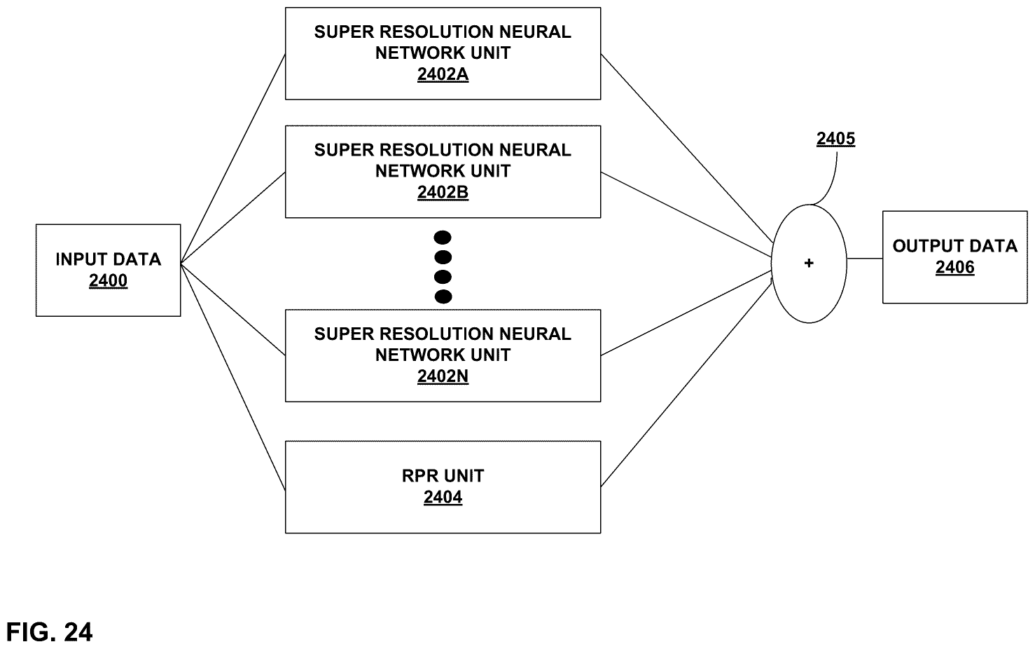

There may be issues with using NN-based techniques. NN-based filtering methods proposed with respect to JVET-AC0155, have been proposed and tested in JVET NNVC software in a form of post-processing with utilization framework roughly depicted in FIG. 24. Scaling Factor 2 was tested by JVET. ARC methods, implemented by VVC RPR technique is used for resolution change within a coding loop of codec. However, it is expected that wide range of scaling factors would need to be used in practical applications, as pointed out in ARC (adaptive resolution change) description above. To accommodate a wide range of scaling factors, currently proposed methods would require a separate NN model architecture, separate training and separate trained model data (side information) for each of the scaling factors. This is expected to lead to a significant increase in the memory requirements and implementation complexity.

For example, as illustrated in FIG. 24, there are a plurality of super resolution (SR) neural network (NN) (SRNN) units 2402A-2402N that may be each associated with different scaling factors (e.g., target output resolution). RPR unit 2404 may be configured to perform reference picture resampling, such as interpolation or other filtering techniques. The output from each may be added together with adder 2405 to generate output data 2406. Input data 2400 may be a block of video data (e.g., after or without initial filtering such as SAO or other NN-ILF techniques) including luma and chroma components, and output data 2406 may be a super resolution block including luma and chroma components. In this example, each of SSNR units 2402A-2402N may be a separate NN model architecture, with separate training and separate trained model data (side information) for each of the scaling factors.

Another challenge of the proposed SR methods is a computation complexity. Both methods introduce NN-based filtering in addition to NN-based In-Loop Filter (NN-ILF) and RPR filter. Complexity of NN filters is significantly larger than conventional video coding tools of VVC, such as interpolation filter of RPR. Therefore, introducing of the additional NN-based SR filter sequentially to existing NN-based loop filter, as may be not providing optimal performance-complexity tradeoff.

The following describes example techniques that may address the above issues. The techniques should not be considered as limited or requiring to address the above issues.

To improve complexity-performance tradeoffs of NN-based SR methods in video coding and enable support of multiple scaling factors in NN filters used for Adaptive Resolution Change (ARC), several alternative architectures and inference techniques are described.

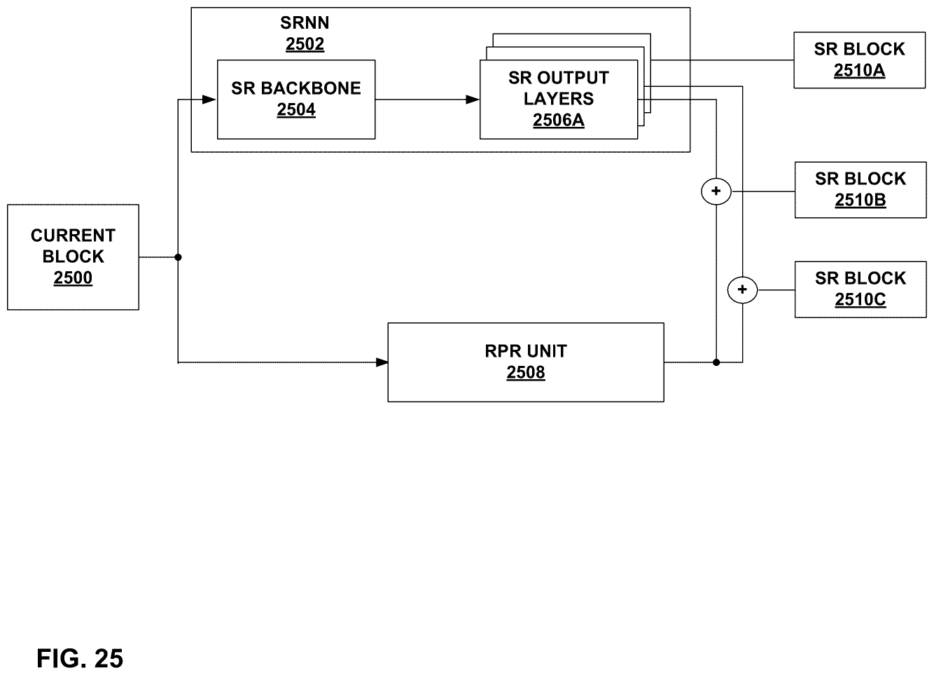

To enable support of multiple scale factors with reduced memory requirement, side information and training complexity, examples of NNSR architecture are described. A simplified block diagram of the architecture is shown in FIG. 25. In the architecture of FIG. 25, SRNN 2502 comprises of two components: SR backbone 2504 implementing NN-filter common for all resolutions, including no change of resolution (e.g., equivalent of the NN-ILF), and SR output layers 2506A-2506N, implementing NN-based resampling to the target output resolution. In some examples, SR backbone 2504 may also receive as input scale factor information that SR backbone 2504 uses for generating intermediate filtered data that is fed to SR output layers 2506A-2506N.

In some examples, SR backbone 2504 and multiple SR output layers 2506A can be implemented in single NN architecture with SR output layers 2506A being branched with network, similarly to luma/chroma branches of NNVC LOP2. Stated another way, in some examples, SR backbone 2504 and the plurality of SR output layers 2506A-2506N are implemented in a single NN architecture. In some examples, SR backbone 2504 and SR output layers 2506A-2506N may be separated in different networks, and being communicated by external process, e.g. during inference. Stated another way, in some examples, SR backbone 2504 and the plurality of SR output layers 2506A-2506N are implemented in a separate, different NN architectures. Such model separation may allow greater flexibility in supporting of multiple scale factors and NN models updates.

In some examples, SR backbone 2504 operates at the input resolution and may be used as ILF or combined with existing ILF for video coding through the mean of data scope, format and inference method, e.g. RDO of encoder. For example, a headblock of SR backbone 2504 may receive scale factor information for modifying a resolution of a current block 2500 of the video data. SR backbone 2504 may filter, based on the scale factor information, current block 2500 to generate intermediate filtered data. In this example, SR backbone 2504 may implement a NN-filter that utilizes the scale factor information. The intermediate filter data may be feature data such as luma component feature data and chroma component feature data of the luma component and the chroma component of current block 2500.

In some examples, the NN-filter of SR backbone 2504 may be common for all resolutions. That is, SR backbone 2504 may apply the same filtering operations for all resolutions but would also include as input the scale factor information (e.g., in the headblock of SR backbone 2504). This way, the intermediate filtered data (e.g., luma component feature data and chroma component feature data) may be better optimized for the target output resolution indicated by the scale factor information.

SRNN 2502 may be configured to a super resolution current block (e.g., one of SR block 2510A, SR block 2510B, or SR block 2510C) based on the intermediate filtered data. The super resolution current block (e.g., one of SR block 2510A, SR block 2510B, or SR block 2510C) has a resolution different than the resolution of the current block 2500. In the example illustrated in FIG. 25, video encoder 200 or video decoder 300 may select a SR output layer from a plurality of SR output layers 2506A-2506N based on the scale factor information. Each of the plurality of SR output layers 2506A-2506N is trained to implement NN-based resampling for a target output resolution to generate a block having the target output resolution.

In this example, SRNN 2502 may generate, using the selected SR output layer, the super resolution current block (e.g., one of SR block 2510A, SR block 2510B, or SR block 2510C). However, in some examples, the output from SR backbone 2504 may be the super resolution current block. In such examples, SR output layers 2506A-2506N may not be needed. Also, it may be possible that SR backbone 2504 performs different operations based on the resolution.

As illustrated in FIG. 25, in some examples, RPR unit 2508 may also generate a different resolution block that is combined with the output from SR output layers 2506A-2506N to generate the super resolution current block. The use of RPR unit 2508 may be optional. However, some devices may support RPR unit 2508, but may not have the processing or memory storage capabilities to implement SRNN 2502. For such devices, only RPR unit 2508 may be used to generate a super resolution current block.

Even for devices that have the capability of implementing SRNN 2502, video encoder 200 and video decoder 300 may utilize RPR unit 2508 to generate a base layer of current block 2500. Video encoder 200 and video decoder 300 may utilize SRNN 2502 (e.g., output of selected one of SR output layers 2506A-2506N) to generate an enhancement layer based on the intermediate filtered data (e.g., luma and chroma component feature data output from SR backbone 2504). As illustrated in FIG. 25 with the adders, video encoder 200 and video decoder 300 may combine the enhancement layer and the base layer to generate the super resolution current block.

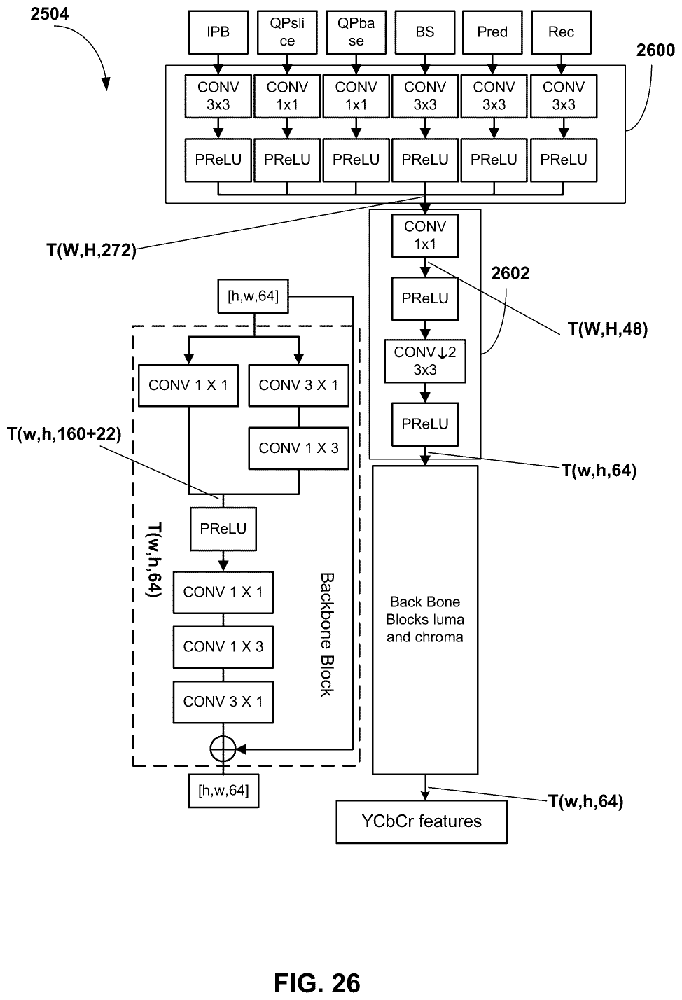

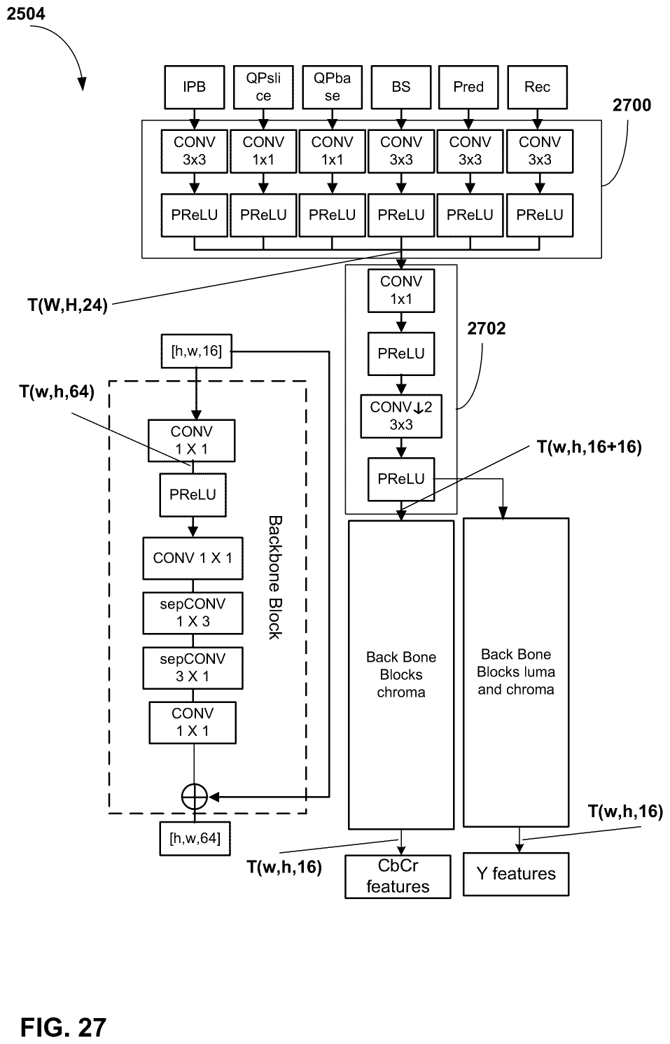

Examples of implementations of SR backbone 2504 based on JVET ILF LOP and HOP resolutions are shown in FIGS. 26 and 27. FIG. 26 is a block diagram illustrating NN-SR backbone filter architecture derived from HOP2 (high operation point). FIG. 27 is a block diagram illustrating NN-SR backbone filter architecture derived from LOP2 (low operation point). Similarly to the base architectures, the reconstructed and predicted samples of chroma components (Cb,Cr) are upsampled to a resolution of the Y component, if needed.

For example, in FIG. 26, SR backbone 2504 includes headblock 2600 that receives as input the IPB mode (e.g., whether intra-frame (I), predicted frame (P), or bi-directional predicted frame (B)), the QP slice parameter, the QP base parameter, the boundary strength (BS), the prediction block (e.g., block used to predict current block 2500), and current block 2500. Although not shown in FIG. 26, headblock 2600 may also receive as input the scale factor information. The inputs other than the scale factor information may be referred to as supplementary input data.

Headblock 2600 (e.g., using the convolution and PRELU functions) may be configured to extract feature information from the scale factor information and the one or more supplementary input data. Headblock 2600 may combine (e.g., concatenate) the feature information (e.g., of the scale factor information and the supplementary input data) to generate combined information. SR backbone 2504 of FIG. 26 may then filter current block 2500 based on the combined information.

For instance, fusion block 2602 may fuse the combined information and extract features of the combined information for output to the backbone blocks for luma and chroma. The components of the backbone blocks for luma and chroma are also illustrated in FIG. 26. The output of the backbone blocks for luma and chroma may be the filtered intermediate data (e.g., luma and chroma component feature data, represented as YCbCr features in FIG. 26).

As illustrated in FIG. 26, the output of headblock 2600 may be tensor (e.g., layer output). The width of the tensor is W, the height of the tensor is H, and the 272 represents the number of channels. In fusion block 2602, the tensor is reduced to 48 channels, and then increased again to 64. In the backbone, the tensor has 182 channels, reduced down to 64. The YCbCr (luma and chroma) features have 64 channels.

The example of SR backbone 2504 in FIG. 27 may be similar to that of FIG. 26, but the luma component feature data and the chroma component feature data may be separately generated. For example, in FIG. 27, SR backbone 2504 includes headblock 2700 that receives as input the IPB mode (e.g., whether intra-frame (I), predicted frame (P), or bi-directional predicted frame (B)), the QP slice parameter, the QP base parameter, the boundary strength (BS), the prediction block (e.g., block used to predict current block 2500), and current block 2500. Although not shown in FIG. 27, headblock 2700 may also receive as input the scale factor information. The inputs other than the scale factor information may be referred to as supplementary input data.

Headblock 2700 (e.g., using the convolution and PRELU functions) may be configured to extract feature information from the scale factor information and the one or more supplementary input data. Headblock 2700 may combine (e.g., concatenate) the feature information (e.g., of the scale factor information and the supplementary input data) to generate combined information. SR backbone 2504 of FIG. 27 may then filter current block 2500 based on the combined information.

For instance, fusion block 2702 may fuse the combined information and extract features of the combined information for output to the backbone blocks for luma and chroma. The components of the backbone blocks for luma and chroma are also illustrated in FIG. 27. However, in FIG. 27, there may be backbone blocks chroma that generates the chroma component feature data (e.g., which is one example of the filtered intermediate data), and backbone blocks luma and chroma generates the luma component feature data and may also generate the chroma component feature data that is discarded. The output of the backbone blocks for luma and chroma may be the filtered intermediate data (e.g., luma and chroma component feature data, represented as Y features in FIG. 27 for the luma component feature data and CbCr features in FIG. 27 for the chroma components).

As illustrated in FIG. 27, the output of headblock 2700 may be tensor (e.g., layer output). The width of the tensor is W, the height of the tensor is H, and the 24 represents the number of channels. In fusion block 2702, the tensor output has 32 channels. In the backbone, the tensor has 64 channels. The CbCr (chroma) features and the Y (luma) features have 16 channels.

In some examples, other parameter configurations or structure of SRNN backbone 2504 or its subcomponents may be used. In some examples, a reduced complexity Fusion Block, e.g. without downsampling convolution (3×3, with stride 2) and sequential activation nonlinearity (PReLU) may be used, similarly to the architecture in FIG. 23.

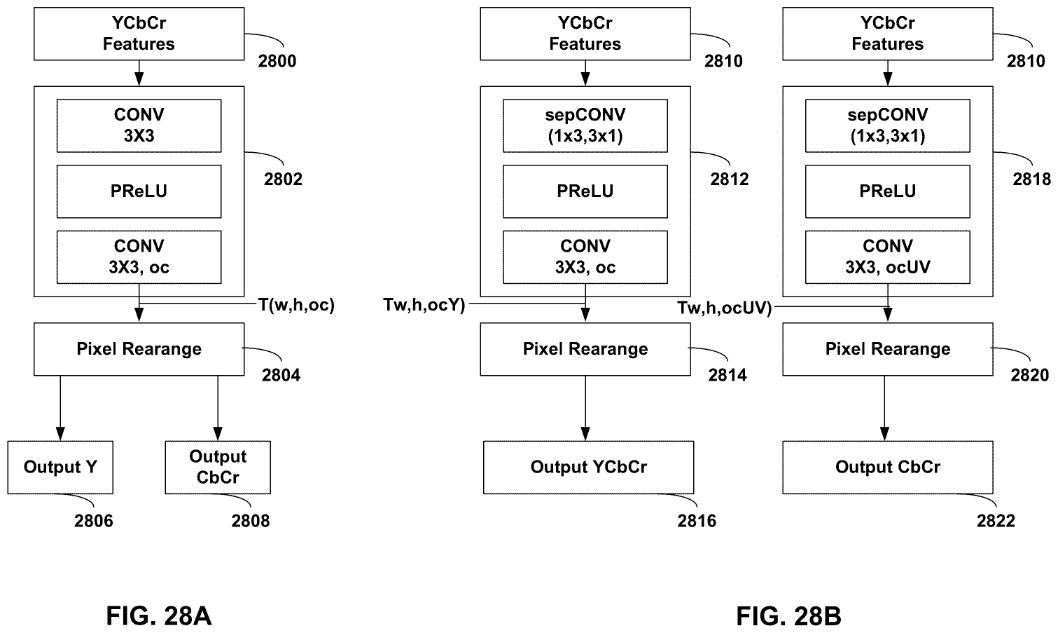

Examples of SR output layers 2506A-2506N are shown in FIGS. 28A and 28B for a NN architecture with a single branch for Y, CbCr components, e.g. FIG. 28A, and NN architecture with separate branches for Y and CbCr components, e.g. FIG. 28B. Tail block parameter oc determines number of output channels (2D planes). This translates by the means of pixel rearrangement, which reshapes the data tensor to the output with supported output resolution. Example of the relationship of parameters oc (model at FIG. 28A) and oc Y/ocUV (model at FIG. 28B) to the scaling factor are shown in Table below.

| | | |
|---|---|---|
| Scale | FIG. 28A | FIG. 28B |

| Factor | oc | ocY | ocUV |
|---|---|---|---|
| 1 | 6 | 4 | 2 |
| 2 | 24 | 16 | 8 |
| 3 | 54 | 36 | 18 |
| . . . | . . . | . . . | . . . |

As illustrated in FIG. 28A, one of SR output layers 2506A-2506N may receive YCbCR features 2800, which may be the luma and chroma component feature data (e.g., intermediate filtered data) generated by SR backbone 2504. Tail block 2802 may perform convolution and PRELU operations, including having a convolution block that takes as input the oc parameter. Pixel rearrange 2804 may rearrange samples because the resolutions of the luma component and the chroma components may be different. The output may be the luma sample values 2806 for the luma component of the super resolution current block and the chroma sample values 2808 for the chroma components of the super resolution block.

FIG. 28B may be similar to FIG. 28A, but the generation of the luma sample values for the luma component and the chroma sample values for the chroma components may be separated out. As illustrated in FIG. 28B, one of SR output layers 2506A-2506N may receive YCbCR features 2810, which may be the luma and chroma component feature data (e.g., intermediate filtered data) generated by SR backbone 2504.

Tail block 2812 may perform convolution and PRELU operations, including having a convolution block that takes as input the oc parameter. Pixel rearrange 2814 may rearrange samples because the resolutions of the luma component and the chroma components may be different. The output may be the luma sample values for the luma component of the super resolution current block and the chroma sample values for the chroma components of the super resolution block, represented as YCbCr 2816. In this example, generation of the chroma sample values may be optional or may be discarded.

Tail block 2818 may perform convolution and PRELU operations, including having a convolution block that takes as input the ocUV parameter. Pixel rearrange 28120 may rearrange samples because the resolutions of the luma component and the chroma components may be different. The output may be the chroma sample values 2822 for the chroma components of the super resolution block.

Accordingly, in the example of FIG. 28A, video encoder 200 and video decoder 300 may be configured to generate, using the selected SR output layer of SR output layers 2506A-2506N, a luma component and at least one chroma component of the super resolution current block. In the example of FIG. 28B, video encoder 200 and video decoder 300 may be configured to generate, using the selected SR output layer (e.g., with tail block 2812), a luma component of the super resolution current block, and generate, using a second SR output layer (e.g., with tail block 2818), at least one chroma component of the super resolution current block.

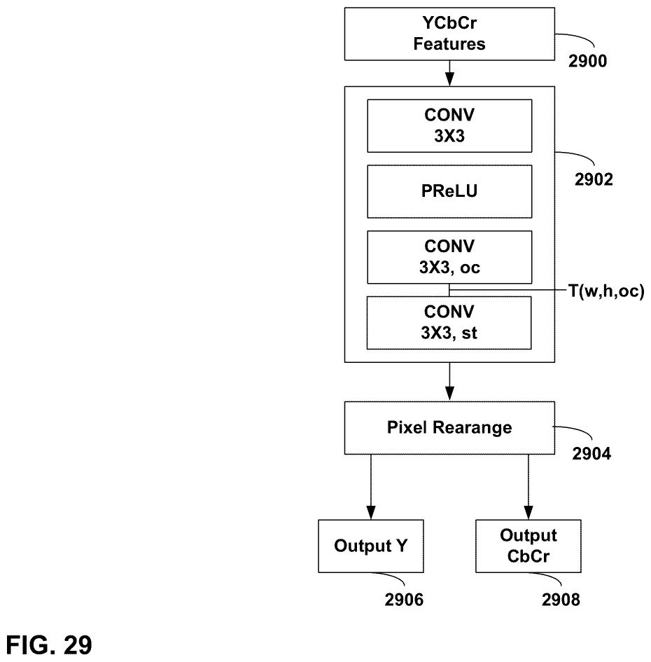

In some examples, SR output layers 2506A-2506N can be modified to include a downsampling process to achieve fractional ratios. Stated another way, in some examples, the resolution of the super resolution current block is a non-integer factor of the resolution of the current block. For example, scaling ratio 1.5 can be achieved by sequentially upsampling data by 3, followed by downsampling by factor of 2. Alternatively, downsampling by 2 can precede the upsampling by 3×. Other fractional scaling ratios can be achieved in similar way. Example of such NNSR output layer with downsampling implemented by conv3×3 with parameter stride st=2 is shown in FIG. 29. In some examples, convolution with stride can take value not equal to 2.

In some examples, NNSR output layers module can be extended by including additional convolution or activation layers. Multiple layers of convolutions with stride >1 can be employed to extend range spatial filter support and range of achievable scaling factors.

As illustrated in FIG. 29, one of SR output layers 2506A-2506N may receive YCbCR features 2900, which may be the luma and chroma component feature data (e.g., intermediate filtered data) generated by SR backbone 2504. Tail block 2902 may perform convolution and PRELU operations, including having a convolution block that takes as input the oc parameter followed by a convolution block that takes st as input. By using the oc parameter and the st parameter it may be possible to achieve a resolution of the super resolution current block that is a non-integer factor of the resolution of current block 2500. Pixel rearrange 2904 may rearrange samples because the resolutions of the luma component and the chroma components may be different. The output may be the luma sample values 2906 for the luma component of the super resolution current block and the chroma sample values 2908 for the chroma components of the super resolution block.

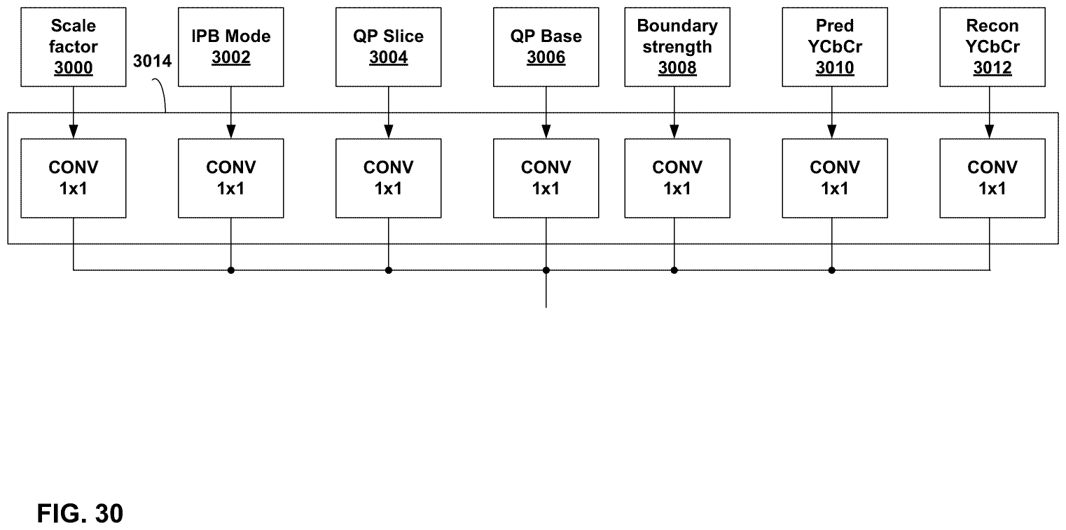

In some examples, set of supplementary input data (context) provided to the SR backbone 2504 architecture can be extended to include indicator of the target scaling factor (e.g., scale factor information). Scale factor indicator (also called scale factor information) can be provided as independent input, similar to QP or BS values, or can be aggregated with other supplementary data, such as IPB mode. Example of architecture with extended input data is shown in FIG. 30.

For example, in FIG. 30, headblock 3014, which is an example of a headblock of SR backbone 2504, may receive as input scale factor information 3000, IPB mode 3002, QP slice 3004, QP base 3006, boundary strength 3008, prediction block 3010, and reconstructed block (e.g., current block 2500) 3012. Using the convolution blocks, and PRELU (not shown) blocks of headblock 3014, headblock 3014 may extract feature information from scale factor information 3000 and one or more supplementary input data (e.g., one or more of IPB mode 3002, QP slice 3004, QP base 3006, boundary strength 3008, prediction block 3010, and reconstructed block 3012). Headblock 3014 may be configured to combine the feature information to generate combined information, and SR backbone 2504 may then filter current block 2500 based on the combined information (e.g., via the fusion blocks and the backbone blocks for luma and chroma as illustrated in FIGS. 26 and 27).

The example techniques may be applicable to in-loop filters with a wide range of complexity by choosing different parameter configurations. With the example techniques, NNVC architectures could reduce computation complexity and memory bandwidth requirements and provide a competitive performance. Examples described in this document are related to NN-assisted loop filtering, however, the example techniques are applicable to any NN-based video coding tool that consumes input data with certain statistical properties, such as static content or sparse representation.

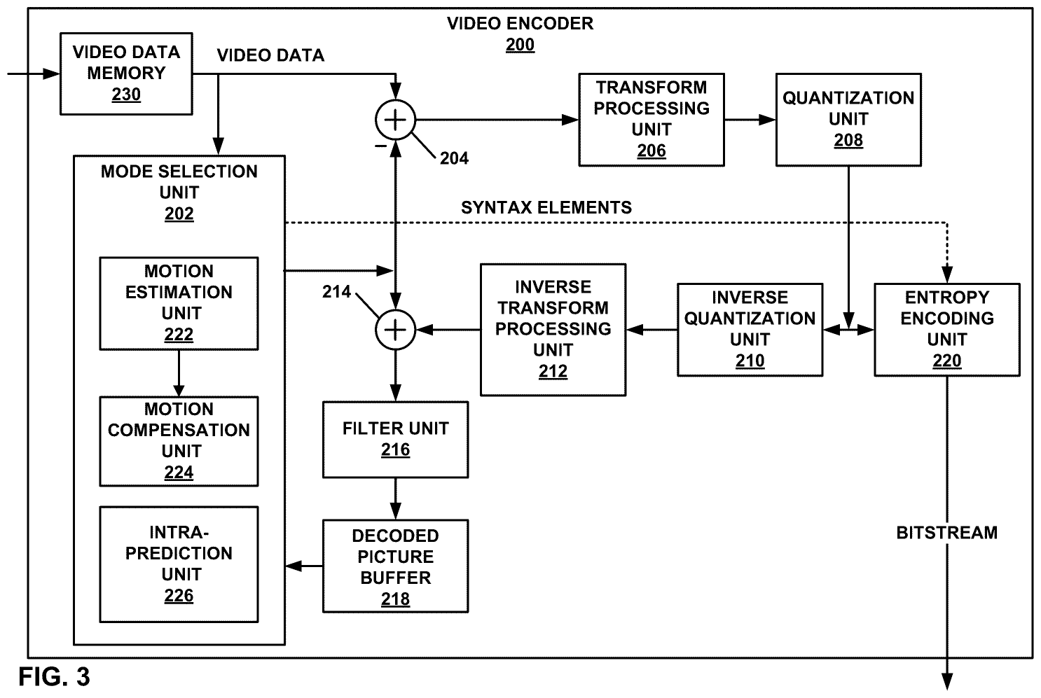

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples. In one or more examples, filter unit 216 may be configured to perform the example techniques of this disclosure. For example, filter unit 216 may include SRNN 2502 and RPR unit 2508, as illustrated in FIG. 25.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to perform the example techniques described in this disclosure.

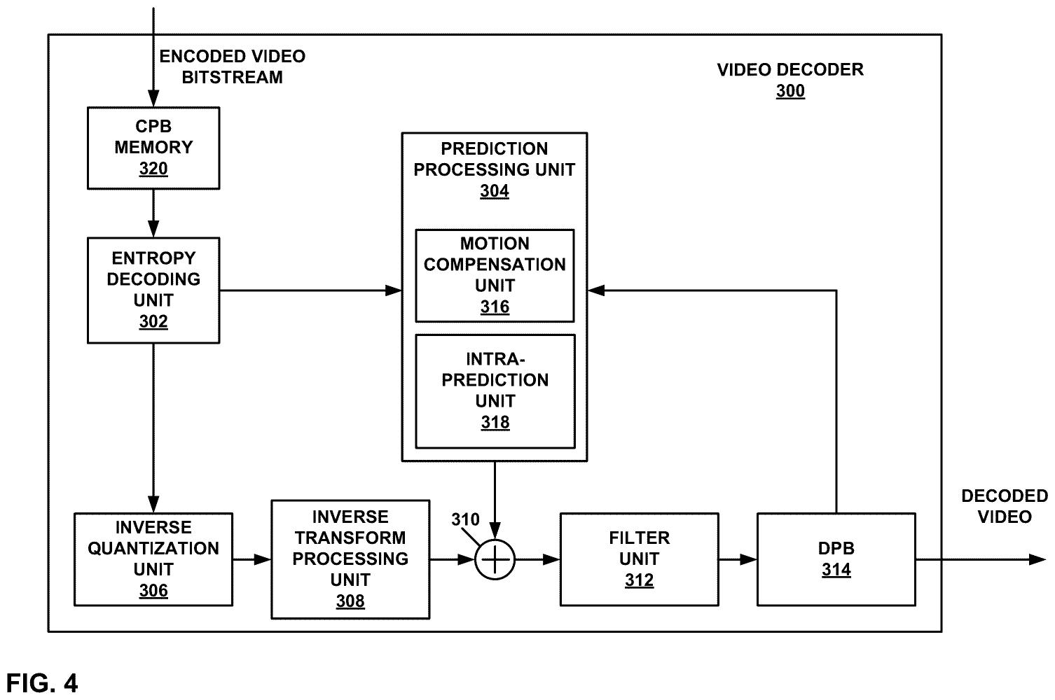

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 3).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples. In one or more examples, filter unit 312 may be configured to perform the example techniques of this disclosure. For example, filter unit 312 may include SRNN 2502 and RPR unit 2508, as illustrated in FIG. 25.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to perform the example techniques described in this disclosure.

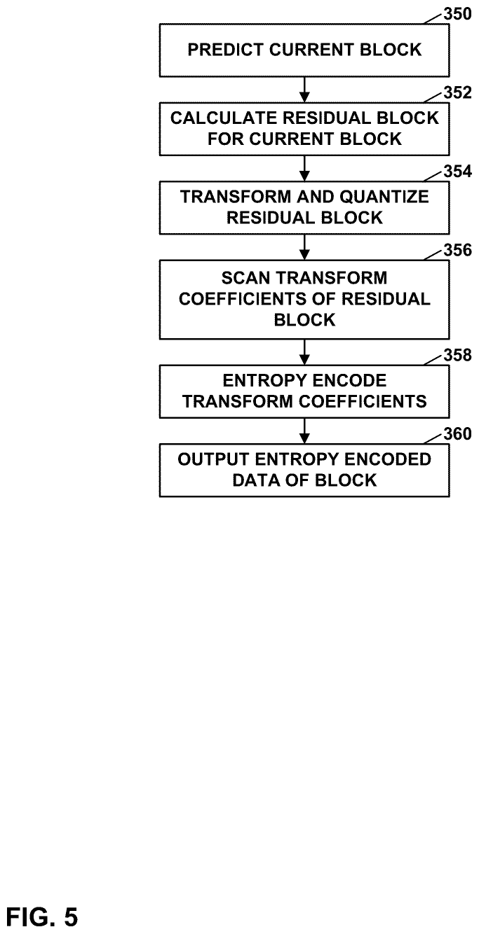

FIG. 5 is a flowchart illustrating an example method for encoding a current block in accordance with the techniques of this disclosure. The current block may comprise a current CU. Although described with respect to video encoder 200 (FIGS. 1 and 3), it should be understood that other devices may be configured to perform a method similar to that of FIG. 5.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

FIG. 6 is a flowchart illustrating an example method for decoding a current block of video data in accordance with the techniques of this disclosure. The current block may comprise a current CU. Although described with respect to video decoder 300 (FIGS. 1 and 4), it should be understood that other devices may be configured to perform a method similar to that of FIG. 6.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

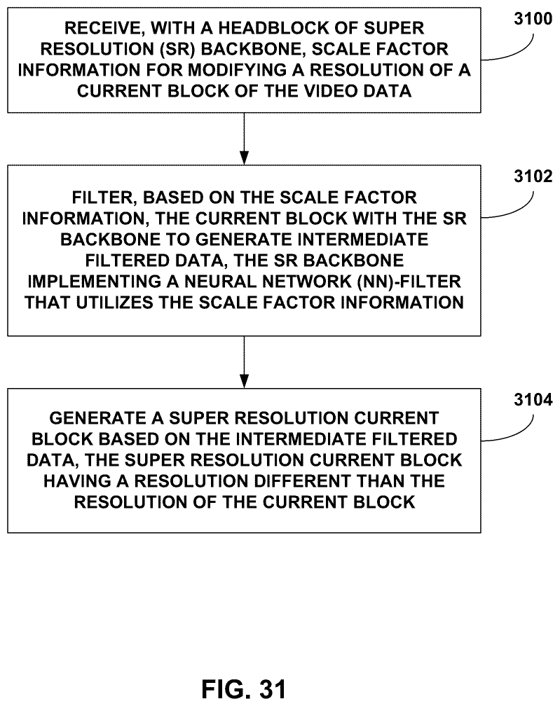

FIG. 31 is a flowchart illustrating an example method of processing video data. For ease, reference is made to FIGS. 25-30. Headblock 3014, which is an example of headblock 2600 or headblock 2700, of SR backbone 2504 being implemented by video encoder 200 or video decoder 300, may receive scale factor information 3000 for modifying a resolution of current block 2500 of the video data (3100). Scale factor information 3000 may be separate input as illustrated in FIG. 30, or may be combined with other supplementary input data such as IPB mode 3002, QP slice 3004, QP base 3006, boundary strength 3008, prediction block 3010, and reconstructed block (e.g., current block 2500) 3012.

Video encoder 200 or video decoder 300 may filter, based on the scale factor information, the current block 2500 with the SR backbone 2504 to generate intermediate filtered data (3102). SR backbone 2504 may implement a NN-filter that utilizes the scale factor information. For example, fusion block 2602 (FIG. 26) or 2702 (FIG. 27) and the respective backbone blocks for luma and/or chroma of FIGS. 26 and 27 may filter current block 2500, where the weights and offsets of the convolution and PRELU blocks may be adjusted or controlled by the scale factor information 3000. The intermediate filtered data may be the luma and chroma component feature data, such as YCbCr features of FIG. 26, or CbCR features and Y features of FIG. 27. The NN-filter of SR backbone 2504 may be common for all resolutions (e.g., the process may be the same for all resolutions), but the scale factor information 3000 may be another input used to generated the filtered intermediate data.

Video encoder 200 or video decoder 300 may generate a super resolution current block (e.g., one of SR blocks 2510A, 2510B, or 2510C) based on the intermediate filtered data (3104). The super resolution current block may have a resolution different than the resolution of current block 2500. Video encoder 200 and video decoder 300 may store the super resolution current block as a reference block for inter-prediction encoding or decoding a subsequent block. Video decoder 300 may be configured to output for display the super resolution current block.

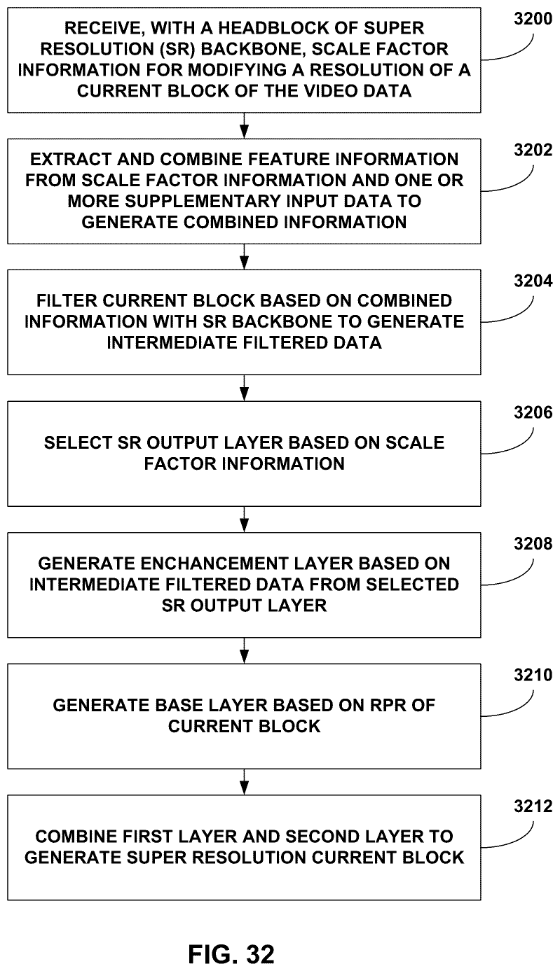

FIG. 32 is a flowchart illustrating an example method of processing video data. For ease, reference is made to FIGS. 25-30. Similar to FIG. 31, headblock 3014, which is an example of headblock 2600 or headblock 2700, of SR backbone 2504 being implemented by video encoder 200 or video decoder 300, may receive scale factor information 3000 for modifying a resolution of current block 2500 of the video data (3200). Scale factor information 3000 may be separate input as illustrated in FIG. 30, or may be combined with other supplementary input data such as IPB mode 3002, QP slice 3004, QP base 3006, boundary strength 3008, prediction block 3010, and reconstructed block (e.g., current block 2500) 3012.

Video encoder 200 or video decoder 300 via SR backbone 2504 may extract feature information from the scale factor information 3000 and one or more supplementary input data (e.g., IPB mode 3002, QP slice 3004, QP base 3006, boundary strength 3008, prediction block 3010, and reconstructed block 3012), and combine the feature information to generate combined information (3202). For example, as illustrated in FIGS. 26, 27, and 30, with the convolution blocks and the PRELU process, headblocks 2600, 2700, or 3014 may extra feature information and combine the feature information.

Video encoder 200 or video decoder 300 via SR backbone 2504 may filter the current block 2500 based on the combined information to generate intermediate filtered data (3204). For instance, for filtering, the combined information may be input into fusion block 2602 or 2702, and fusion block 2602 or 2702 may output to backbone blocks for luma and/or chroma, as illustrated in FIGS. 26 and 27. The intermediate filtered data may be the luma and chroma component feature data, represented as YCbCR features in FIG. 26 or Y features and CbCr features in FIG. 27.

Video encoder 200 or video decoder may select an SR output layer from plurality of SR output layers 2506A-2506N based on the scale factor information 3000 (3206). As described, each of the plurality of SR output layers 2506A-2506N is trained to implement NN-based resampling for a target output resolution to generate a block having the target output resolution. Accordingly, based on the scale factor information, video encoder 200 and video decoder 300 may select the SR output layer that is trained to generate a block having the target output resolution that aligns with the scale factor information.

Video encoder 200 or video decoder 300 may generate an enhancement layer based on the intermediate filtered data (3208). For example, the output from the selected SR output layer from plurality of SR output layers 2506A-2506N may be considered as an enhancement layer. Video encoder 200 or video decoder 300 may generate a base layer based on reference picture resampling (RPR) (e.g., via RPR unit 2508) of the current block 2500 (3210). Video encoder 200 or video decoder 300 may combine the enhancement layer and the base layer to generate the super resolution current block (e.g., one of SR blocks 2510B or 2510C) (3212).

In some examples, video encoder 200 and video decoder 300 may store the super resolution current block as a reference block for inter-prediction encoding or decoding a subsequent block. In some examples, video decoder 300 may output for display the super resolution current block.

The following describes examples techniques that may be implemented together or separately.
Clause 1A. A method of processing video data, the method comprising: filtering video data input with a super resolution (SR) backbone to generate intermediate filtered data, the SR backbone implementing a neural network (NN)-filter that is common for all resolutions of video data; and resampling the intermediate filtered data with one or more SR output layers to generate target output resolution video data, the one or more SR output layers implementing NN-based resampling.
Clause 2A. The method of clause 1A, wherein the SR back and the one or more SR output layers are implemented in a single NN architecture.
Clause 3A. The method of clause 1A, wherein the SR back and the one or more SR output layers are implemented in separate, different NN architectures.
Clause 4A. The method of any of clauses 1A-3A, wherein the method(s) are performed as part of a video decoder generating pictures for display.
Clause 5A. The method of any of clauses 1A-3A, wherein the method(s) are performed as part of a video encoder or a video decoder generating pictures that are used as reference pictures.
Clause 6A. A device for processing video data, the device comprising: one or more memories configured to store the video data; and processing circuitry coupled to the one or more memories and configured to perform the method of any of clauses 1A-5A.
Clause 7A. A device for processing video data, the device comprising one or more means for performing the method of any of clauses 1A-5A.
Clause 8A. The device of clause 7A, wherein the one or more means comprise one or more processors implemented in circuitry.
Clause 9A. The device of any of clauses 7A and 8A, further comprising one or more memories to store the video data.
Clause 10A. The device of any of clauses 6A-9A, further comprising a display configured to display decoded video data.
Clause 11A. The device of any of clauses 6A-10A, wherein the device comprises one or more of a camera, a computer, a mobile device, a broadcast receiver device, or a set-top box.
Clause 12A. The device of any of clauses 6A-11A, wherein the device comprises a video decoder.
Clause 13A. The device of any of clauses 6A-12A, wherein the device comprises a video encoder.
Clause 14A. A computer-readable storage medium having stored thereon instructions that, when executed, cause one or more processors to perform the method of any of clauses 1A-5A.
Clause 1B. A method of processing video data, the method comprising: receiving, with a headblock of a super resolution (SR) backbone, scale factor information for modifying a resolution of a current block of the video data; filtering, based on the scale factor information, the current block with the SR backbone to generate intermediate filtered data, the SR backbone implementing a neural network (NN)-filter that utilizes the scale factor information; and generating a super resolution current block based on the intermediate filtered data, the super resolution current block having a resolution different than the resolution of the current block.
Clause 2B. The method of clause 1B, wherein the intermediate filtered data comprises luma and chroma component feature data.
Clause 3B. The method of any of clauses 1B and 2B, further comprising: extracting feature information from the scale factor information and one or more supplementary input data; and combining the feature information to generate combined information, wherein filtering the current block comprises filtering the current block based on the combined information.
Clause 4B. The method of any of clauses 1B-3B, wherein the NN-filter is common for all resolutions.
Clause 5B. The method of any of clauses 1B-4B, further comprising: selecting a SR output layer from a plurality of SR output layers based on the scale factor information, wherein each of the plurality of SR output layers is trained to implement NN-based resampling for a target output resolution to generate a block having the target output resolution, wherein generating the super resolution current block comprises generating, using the selected SR output layer, the super resolution current block.
Clause 6B. The method of clause 5B, wherein generating, using the selected SR output layer, the super resolution current block comprises generating, using the selected SR output layer, a luma component and at least one chroma component of the super resolution current block.
Clause 7. The method of any of clauses 5B and 6B, wherein the selected SR output layer is a first SR output layer, and wherein generating, using the selected SR output layer, the super resolution current block comprises: generating, using the selected SR output layer, a luma component of the super resolution current block; and generating, using a second SR output layer, at least one chroma component of the super resolution current block.
Clause 8B. The method of any of clauses 1B-7B, wherein generating the super resolution current block based on the intermediate filtered data comprises: generating an enhancement layer based on the intermediate filtered data; generating a base layer based on reference picture resampling (RPR) of the current block; and combining the enhancement layer and the base layer to generate the super resolution current block.
Clause 9B. The method of any of clauses 1B-8B, wherein the resolution of the super resolution current block is a non-integer factor of the resolution of the current block.
Clause 10B. The method of any of clauses 1B-9B, further comprising one or more of: storing the super resolution current block as a reference block for inter-prediction encoding or decoding a subsequent block; and outputting for display the super resolution current block.
Clause 11B. A device for processing video data, the device comprising: one or more memories configured to store the video data; and processing circuitry coupled to the one or more memories and configured to: receive, with a headblock of a super resolution (SR) backbone, scale factor information for modifying a resolution of a current block of the video data; filter, based on the scale factor information, the current block with the SR backbone to generate intermediate filtered data, the SR backbone implementing a neural network (NN)-filter that utilizes the scale factor information; and generate a super resolution current block based on the intermediate filtered data, the super resolution current block having a resolution different than the resolution of the current block.
Clause 12B. The device of clause 11B, wherein the intermediate filtered data comprises luma and chroma component feature data.
Clause 13B. The device of any of clauses 11B and 12B, wherein the processing circuitry is configured to: extract feature information from the scale factor information and one or more supplementary input data; and combine the feature information to generate combined information, wherein to filter the current block, the processing circuitry is configured to filter the current block based on the combined information.
Clause 14B. The device of any of clauses 11B-13B, wherein the NN-filter is common for all resolutions.
Clause 15B. The device of any of clauses 11B-14B, wherein the processing circuitry is configured to: select a SR output layer from a plurality of SR output layers based on the scale factor information, wherein each of the plurality of SR output layers is trained to implement NN-based resampling for a target output resolution to generate a block having the target output resolution, wherein to generate the super resolution current block, the processing circuitry is configured to generate, using the selected SR output layer, the super resolution current block.
Clause 16B. The device of clause 15B, wherein to generate, using the selected SR output layer, the super resolution current block, the processing circuitry is configured to generate, using the selected SR output layer, a luma component and at least one chroma component of the super resolution current block.
Clause 17B. The device of any of clauses 15B or 16B, wherein the selected SR output layer is a first SR output layer, and wherein to generate, using the selected SR output layer, the super resolution current block, the processing circuitry is configured to: generate, using the selected SR output layer, a luma component of the super resolution current block; and generate, using a second SR output layer, at least one chroma component of the super resolution current block.
Clause 18B. The device of any of clauses 11B-17B, wherein to generate the super resolution current block based on the intermediate filtered data, the processing circuitry is configured to: generate an enhancement layer based on the intermediate filtered data; generate a base layer based on reference picture resampling (RPR) of the current block; and combine the enhancement layer and the base layer to generate the super resolution current block.
Clause 19B. The device of any of clauses 11B-18B, wherein the resolution of the super resolution current block is a non-integer factor of the resolution of the current block.
Clause 20B. A computer-readable storage medium having stored thereon instructions that, when executed, cause one or more processors to: receive, with a headblock of a super resolution (SR) backbone, scale factor information for modifying a resolution of a current block of video data; filter, based on the scale factor information, the current block with the SR backbone to generate intermediate filtered data, the SR backbone implementing a neural network (NN)-filter that utilizes the scale factor information; and generate a super resolution current block based on the intermediate filtered data, the super resolution current block having a resolution different than the resolution of the current block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
receiving, with a headblock of a super resolution (SR) backbone, scale factor information for modifying a resolution of a current block of the video data;
filtering, based on the scale factor information, the current block with the SR backbone to generate intermediate filtered data, the SR backbone implementing a neural network (NN)-filter that utilizes the scale factor information; and
generating a super resolution current block based on the intermediate filtered data, the super resolution current block having a resolution different than the resolution of the current block.

2. The method of claim 1, wherein the intermediate filtered data comprises luma and chroma component feature data.

3. The method of claim 1, further comprising:
extracting feature information from the scale factor information and one or more supplementary input data; and
combining the feature information to generate combined information,
wherein filtering the current block comprises filtering the current block based on the combined information.

4. The method of claim 1, wherein the NN-filter is common for all resolutions.

5. The method of claim 1, further comprising:
selecting a SR output layer from a plurality of SR output layers based on the scale factor information, wherein each of the plurality of SR output layers is trained to implement NN-based resampling for a target output resolution to generate a block having the target output resolution,
wherein generating the super resolution current block comprises generating, using the selected SR output layer, the super resolution current block.

6. The method of claim 5, wherein generating, using the selected SR output layer, the super resolution current block comprises generating, using the selected SR output layer, a luma component and at least one chroma component of the super resolution current block.

7. The method of claim 5, wherein the selected SR output layer is a first SR output layer, and wherein generating, using the selected SR output layer, the super resolution current block comprises:
generating, using the selected SR output layer, a luma component of the super resolution current block; and
generating, using a second SR output layer, at least one chroma component of the super resolution current block.

8. The method of claim 1, wherein generating the super resolution current block based on the intermediate filtered data comprises:
generating an enhancement layer based on the intermediate filtered data;
generating a base layer based on reference picture resampling (RPR) of the current block; and
combining the enhancement layer and the base layer to generate the super resolution current block.

9. The method of claim 1, wherein the resolution of the super resolution current block is a non-integer factor of the resolution of the current block.

10. The method of claim 1, further comprising one or more of:
storing the super resolution current block as a reference block for inter-prediction encoding or decoding a subsequent block; and
outputting for display the super resolution current block.

11. A device for processing video data, the device comprising:
one or more memories configured to store the video data; and
processing circuitry coupled to the one or more memories and configured to:
receive, with a headblock of a super resolution (SR) backbone, scale factor information for modifying a resolution of a current block of the video data;
filter, based on the scale factor information, the current block with the SR backbone to generate intermediate filtered data, the SR backbone implementing a neural network (NN)-filter that utilizes the scale factor information; and
generate a super resolution current block based on the intermediate filtered data, the super resolution current block having a resolution different than the resolution of the current block.

12. The device of claim 11, wherein the intermediate filtered data comprises luma and chroma component feature data.

13. The device of claim 11, wherein the processing circuitry is configured to:
extract feature information from the scale factor information and one or more supplementary input data; and
combine the feature information to generate combined information,
wherein to filter the current block, the processing circuitry is configured to filter the current block based on the combined information.

14. The device of claim 11, wherein the NN-filter is common for all resolutions.

15. The device of claim 11, wherein the processing circuitry is configured to:
select a SR output layer from a plurality of SR output layers based on the scale factor information, wherein each of the plurality of SR output layers is trained to implement NN-based resampling for a target output resolution to generate a block having the target output resolution,
wherein to generate the super resolution current block, the processing circuitry is configured to generate, using the selected SR output layer, the super resolution current block.

16. The device of claim 15, wherein to generate, using the selected SR output layer, the super resolution current block, the processing circuitry is configured to generate, using the selected SR output layer, a luma component and at least one chroma component of the super resolution current block.

17. The device of claim 15, wherein the selected SR output layer is a first SR output layer, and wherein to generate, using the selected SR output layer, the super resolution current block, the processing circuitry is configured to:
generate, using the selected SR output layer, a luma component of the super resolution current block; and
generate, using a second SR output layer, at least one chroma component of the super resolution current block.

18. The device of claim 11, wherein to generate the super resolution current block based on the intermediate filtered data, the processing circuitry is configured to:
generate an enhancement layer based on the intermediate filtered data;
generate a base layer based on reference picture resampling (RPR) of the current block; and
combine the enhancement layer and the base layer to generate the super resolution current block.

19. The device of claim 11, wherein the resolution of the super resolution current block is a non-integer factor of the resolution of the current block.

20. A computer-readable storage medium having stored thereon instructions that, when executed, cause one or more processors to:
receive, with a headblock of a super resolution (SR) backbone, scale factor information for modifying a resolution of a current block of video data;
filter, based on the scale factor information, the current block with the SR backbone to generate intermediate filtered data, the SR backbone implementing a neural network (NN)-filter that utilizes the scale factor information; and
generate a super resolution current block based on the intermediate filtered data, the super resolution current block having a resolution different than the resolution of the current block.
